(19) United States
(12) Patent Application Publication
(10) Pub. No.: US 2016/0021039 A1
(43) Pub. Date: Jan. 21, 2016

(54) MESSAGE CONTROL FUNCTIONS WITHIN COMMUNICATION SYSTEMS

(71) Applicants: Thomas Y. Woo, Short Hills, NJ (US); Markus A. Hofmann, Fair Haven, NJ (US); James R. Ensor, Red Bank, NJ (US)

(72) Inventors: Thomas Y. Woo, Short Hills, NJ (US); Markus A. Hofmann, Fair Haven, NJ (US); James R. Ensor, Red Bank, NJ (US)

(73) Assignee: Alcatel-Lucent USA Inc., Murray Hill, NJ (US)

(21) Appl. No.: 14/336,133

(22) Filed: Jul. 21, 2014

(51) Int. Cl. H04L 12/58; G06F 3/0484

(52) U.S. Cl. CPC H04L 51/046; H04L 51/26; G06F 3/0484

(57) ABSTRACT

A chat-based communication capability is presented. In at least some embodiments, a chat-based communication capability may utilize a chat-based communication paradigm to support one or more communication interaction types not typically supported by chat-based communication paradigms. In at least some embodiments, a chat-based communication capability may support chat-based communication between a human entity and a non-human entity or between multiple non-human entities. In at least some embodiments, a chat-based communication capability may support extended operations which may be provided within the context of a chat-based system. In at least some embodiments, a chat-based communication capability or other communication or interaction environment may support one or more of relationship identification and notification capabilities, question and answer management functions, message attribution management functions, software developer functions, or the like.

### TECHNICAL FIELD

The disclosure relates generally to communication systems and, more specifically but not exclusively, to providing message control functions within communication systems.

### BACKGROUND

Existing technology provides people with multiple, distinct paradigms for communicating. These communication paradigms are typically associated with specific types of communication interaction types. For example, chat-based communication paradigms may be used for human-to-human interaction, menu-based communication paradigms may be used for human-to-computer interaction, and so forth. While such communication paradigms, and associated communication interaction types, often serve their specific functions well, they also tend to place a significant demand on people using them (e.g., typically requiring their users to learn specific, often distinct, and sometimes conflicting vocabulary and syntax).

### SUMMARY OF EMBODIMENTS

Various deficiencies in the prior art are addressed by embodiments for providing message control functions.

In one embodiment, an apparatus includes a processor and a memory communicatively connected to the processor, where the processor is configured to receive, via an interactive message environment supporting a user group including a set of users, a message from one of the users of the user group, and perform a control action via the interactive message environment based on a determination that the message includes a question. In one embodiment, a method includes using a processor and a memory for receiving, via an interactive message environment supporting a user group including a set of users, a message from one of the users of the user group, and performing a control action via the interactive message environment based on a determination that the message includes a question.

In one embodiment, an apparatus includes a processor and a memory communicatively connected to the processor, where the processor is configured to receive a message of a user where the message is intended for posting to an interactive message environment and where a message attribution for the message is indicative that the message is attributed to the user, modify the message attribution for the message to form a modified message attribution for the message, and initiate posting of the message to the interactive message environment using the modified message attribution for the message. In one embodiment, a method includes using a processor and a memory for receiving a message of a user where the message is intended for posting to an interactive message environment and where a message attribution for the message is indicative that the message is attributed to the user, modifying the message attribution for the message to form a modified message attribution for the message, and initiating posting of the message to the interactive message environment using the modified message attribution for the message.

### BRIEF DESCRIPTION OF THE DRAWINGS

The teachings herein can be readily understood by considering the detailed description in conjunction with the accompanying drawings, in which:

FIG. 1 depicts an exemplary chat-based system configured to support chat-based communications for multiple communication interaction types;

FIG. 2 depicts an exemplary embodiment of a method for supporting chat-based communications for multiple communication interaction types;

FIG. 3 depicts an exemplary embodiment of a method for supporting chat-based communications;

FIG. 4 depicts the exemplary chat-based system of FIG. 1, illustrating various functions which may be provided within the context of the exemplary chat-based system of FIG. 1;

FIG. 5 depicts an exemplary embodiment of a method for supporting extended operations functions within a chat-based system;

FIG. 6 depicts an exemplary embodiment of a method for supporting relationship identification and notification within a chat-based system;

FIG. 7 depicts an exemplary embodiment of a method for supporting question and answer management functions;

FIG. 8 depicts an exemplary embodiment of a method for supporting message attribution management functions; and

FIG. 9 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

A chat-based communication capability is presented herein. In at least some embodiments, the chat-based communication capability utilizes a chat-based communication paradigm to support one or more communication interaction types not typically supported by chat-based communication paradigms.

In at least some embodiments, the chat-based communication capability may support chat-based communication between a human entity and a non-human entity (e.g., a device, a program running on a device, a process, an organization, or the like). In at least some embodiments, in addition to or in place of human-human communication typically supported by chat applications, a chat application may be configured to support one or more other communication interaction types for communication between a human entity and a non-human entity, such as one or more of human-device communications between a human and a device (e.g., a content server, a printer, a camera, or the like), human-program communications between a human and a program (e.g., an online e-commerce program, a restaurant order and payment processing program, a human resources program, or the like), human-process communications between a human and a process (e.g., a group conversation, a collaborative session, a digital conference, or the like), human-organization communications between a human and an organization (e.g., a business, a not-for-profit organization, an educational organization, or the like), or the like, as well as various combinations thereof.

In at least some embodiments, the chat-based communication capability may support chat-based communication between multiple non-human entities (e.g., where the non-human entities may include devices, programs, processes, organizations, or the like). In at least some embodiments, a chat application may be configured to support one or more communication interaction types for communication between multiple non-human entities, such as one or more of device-device communications between devices (which also may be referred to herein as machine-to-machine (M2M) communications), device-program communications between a device and a program, program-program communications between programs, device-process communications between a device and a process, program-process communications between a program and a process, process-process communications, and so forth.

Various embodiments of the chat-based communication capability provide a convenient and uniform way for human and non-human entities to communicate using different communication interaction types (e.g., to communicate with humans, to interact with devices, to interface with computer programs, to participate in processes, to interact with organizations, or the like) using a common chat-based communication paradigm. Various embodiments of the chat-based communication capability provide a convenient way for human and non-human entities to easily and seamlessly move between different communication interaction types. Various embodiments of the chat-based communication capability provide a comprehensive chat-based communication interface, supporting various communication interaction types, which allow human and non-human entities to participate in a wide range of communication interaction types more readily, intuitively, quickly, and simply.

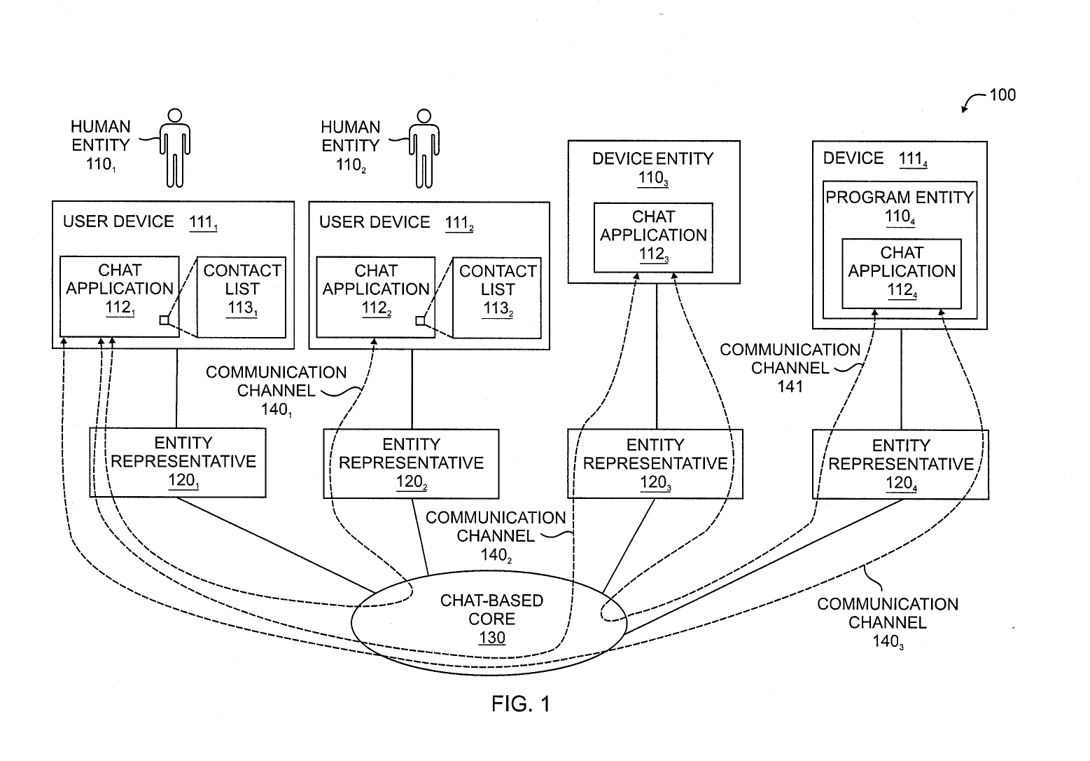

These and various other embodiments and advantages of the chat-based communication capability may be better understood by way of reference to the exemplary chat-based system of FIG. 1.

FIG. 1 depicts an exemplary chat-based system configured to support chat-based communications for multiple communication interaction types.

The chat-based system 100 includes a set of entities 110₁-110₄ (collectively, entities 110), a set of entity representatives 120₁-120₄ (collectively, entity representatives 120) associated with respective entities 110₁-110₄, and a chat-based core 130. The entities 110 include human entities (illustratively, a human entity 110₁ and a human entity 110₂) and non-human entities (illustratively, device entity 110₃ and a program entity 110₄). The chat-based system 100 is configured to support multiple communication interactions types between entities 110, which may include chat-based communications involving a human entity (primarily depicted and described herein from the perspective of the human entity 110₁) or chat-based communications that do not involve a human entity. The chat-based communications involving a human entity may include chat-based communication between human entities (e.g., a typical chat session between human entity 110₁ and human entity 110₂), chat-based communication between a human entity and a non-human entity (e.g., again, primarily depicted and described herein from the perspective of human entity 110₁), or the like. The chat-based communications that do not involve a human entity may include chat-based communications between devices, chat-based communications between a device and a program, chat-based communications between programs, or the like. The entity representatives 120 and chat-based core 130 are configured to facilitate communications between various entities 110 as discussed in additional detail below.

As discussed above, chat-based system 110 may support multiple communication interaction types for a human entity (illustratively, for human entity 110₁). The human entity 110₁ is using an associated user device 111₁ supporting a chat application 112₁. The user device 111₁ of human entity 110₁ may be a computer, smartphone, or any other device suitable for executing chat application 112₁. The chat application 112₁ is an enhanced chat application that is configured to provide more functions than a typical chat application (namely, chat application 112₁ is configured to support multiple communication interaction types in addition to human-to-human communications). The chat application 112₁ is executing on user device 111₁ such that the human entity 110₁ may utilize chat application 112₁ to engage in various types of chat-based communication interactions (e.g., human-to-human, human-device, human-program, or the like) as discussed further below. The chat application 112₁ provides a chat-based communication interface via which human entity 110₁ may provide information for propagation to other entities 110 and via which human entity 110₁ may receive information from other entities 110. The chat application 112₁ supports establishment of communication channels between chat application 112₁ and chat applications running on other entities 110 (described below), such that information provided by human entity 110₁ via the chat-based communication interface of chat application 112₁ may be propagated to other entities 110 and, similarly, such that information from other entities 110 may be propagated to chat application 112₁ for presentation to human entity 110₁. The chat application 112₁ has associated therewith a contact list 113₁, which includes a list of other entities 110 that are associated with human entity 110₁ via chat application 112₁ (illustratively, human entity 110₂, device entity 110₃, and program entity 110₄, as discussed further below) and, thus, with which chat application 112₁ may support communication channels for chat-based communications with other entities 110. The chat application 112₁, including associated contact list 113₁, may be adapted for display to human entity 110₁ via one or more presentation interfaces of user device 111₁ (although it will be appreciated that chat application 112₁ also may continue to run even when not displayed). It will be appreciated that, although primarily depicted and described with respect to embodiments in which chat application 112₁ runs exclusively on user device 111₁ (and, similarly, associated contact list 113₁ is stored on user device 111₁), at least some components or functions of chat application 112₁ may also or alternatively be running (and, similarly, at least a portion of contact list 113₁ also or alternatively may be stored) on one or more other elements (e.g., entity representative 120₁, chat-based core 130, one or more other elements, or the like, as well as various combinations thereof).

The chat-based system 100 supports a typical human-to-human interaction between human entity 110₁ and human entity 110₂. The human entity 110₂ is using an associated user device 111₂ supporting a chat application 112₂. The user device 111₂ of human entity 110₂ may be a computer, smartphone, or any other device suitable for executing chat application 112₂. The chat application 112₂ may be a typical chat application that only supports a single interaction type (i.e., human-to-human communications) or may be an enhanced chat application (e.g., such as chat application 112₁ being used by human entity 110₁). The chat application 112₂ supports a chat-based communication interface via which human entity 110₂ may provide information for propagation to human entity 110₁ and via which human entity 110₂ may receive information from human entity 110₁. The chat application 112₂ has associated therewith a contact list 113₂, which includes a list of other entities 110 that are associated with human entity 110₂ via chat application 112₂ (illustratively, human entity 110₁). The chat application 112₂, including associated contact list 113₂, may be adapted for display to human entity 110₂ via one or more presentation interfaces of user device 111₂. The chat-based system 100 supports establishment of a communication channel 140₁ between the chat application 112₁ of user device 111₁ and the chat application 112₂ of user device 111₂. The communication channel 140₁ between the chat application 112₁ of user device 111₁ and the chat application 112₂ of user device 111₂ supports propagation of chat-based communication between human entity 110₁ and human entity 110₂. For example, human entity 110₁ may use the chat-based communication interface of chat application 112₁ to enter and submit messages intended for human entity 110₂ (which are delivered to chat application 112₂ of user device 111₂ via communication channel 140₁ and presented to human entity 110₂ via the chat-based communication interface of chat application 112₂ of user device 111₂) and, similarly, human entity 110₂ may use the chat-based communication interface of chat application 112₂ to enter and submit messages intended for human entity 110₁ (which are delivered to chat application 112₁ of user device 111₁ via communication channel 140₁ and presented to human entity 110₁ via the chat-based communication interface of chat application 112₁ of user device 111₁). In this manner, human entity 110₁ and human entity 110₂ may carry on a conversation in real time. The typical interaction between human entities within the context of a chat session will be understood by one skilled in the art and, thus, a description of such interaction is omitted. The communication channel 140₁ also traverses entity representatives 120₁ and 120₂ and chat-based core 130, one or more of which may perform various functions in support of the chat-based communication between human entity 110₁ and human entity 110₂ via communication channel 140₁.

The chat-based system 100 supports human-device interaction between human entity 110₁ and entity 110₃, which is a device entity. The device entity 110₃ may be any type of device with which user device 111₁ of human entity 110₁ may communicate. For example, device entity 110₃ may be a network device (e.g., a database from which human entity 110₁ may request information, a content server from which human entity 110₁ may request content or on which human entity 110₁ may store content, or the like), a datacenter device (e.g., a host server hosting a virtual machine accessible to human entity 110₁, a file system accessible to human entity 110₁, or the like), a device available on a local area network (e.g., a computer, a storage device, a printer, a copier, a scanner, or the like), a smart device for a smart environment (e.g., a sensor, an actuator, a monitor, a camera, an appliance, or the like), an end-user device (e.g., a computer, a smartphone, a television, or the like), a vehicle-mounted communication device, a near-field communication device, or the like. The device entity 110₃ includes a chat application 112₃. The chat-based system 100 supports establishment of a communication channel 140₂ between the chat application 112₁ of user device 111₁ and the chat application 112₃ of device entity 110₃. The chat application 112₃ supports a chat-based communication interface via which device entity 110₃ may provide information for propagation to human entity 110₁ and via which device entity 110₃ may receive information from human entity 110₁. The chat-based communication interface may provide an interface between the chat application 112₃ (including the communication channel 140₂ established with chat application 112₃) and one or more modules or elements of device entity 110₃ (e.g., modules or elements configured to process information received via communication channel 140₂, modules or elements configured to provide information for transmission via communication channel 140₂, or the like, as well as various combinations thereof). The chat application 112₃ may have associated therewith a contact list 113₃, which includes a list of other entities 110 that are associated with device entity 110₃ via chat application 112₃ (illustratively, human entity 110₁). The chat application 112₃ is not expected to include a display interface or component, as the device entity 110₃ is expected to participate in chat-based communication via communication channel 140₂ independent of any human interaction.

The communication channel 140₂ between the chat application 112₁ of user device 111₁ and the chat application 112₃ of device entity 110₃ supports propagation of chat-based communication between human entity 110₁ and device entity 110₃. The communication channel 140₂ between the chat application 112₁ of user device 111₁ and the chat application 112₃ of device entity 110₃ may support various types of communication between human entity 110₁ and device entity 110₃, where the types of communication supported may depend on the device type of device entity 110₃. For example, human entity 110₁ may use a chat-based communication interface of chat application 112₁ to send a request for information or content to device entity 110₃ via communication channel 140₂ (e.g., a request for a video file, a request for an audio file, a request for status information from a sensor, a request for status information from a vehicle information system, or the like), and device entity 110₃ may respond to the request by using a chat-based communication interface of chat application 112₃ to send the requested information or content to chat application 112₁ via communication channel 140₂ for making the information or content accessible to human entity 110₁. For example, human entity 110₁ may use a chat-based communication interface of chat application 112₁ to send a control command to device entity 110₃ via communication channel 140₂ (e.g., a command sent to a camera to control reconfiguration of the camera, a command sent to an actuator to control the actuator, a command sent to a printer to control configuration of the printer, a command sent to a device hosting a file system to control retrieval of data from the file system, or the like), and device entity 110₃ may respond to the control command by using a chat-based communication interface of chat application 112₃ to send an associated command result to chat application 112₁ via communication channel 140₂ for informing the human entity 110₁ of the result of execution of the command. For example, device entity 110₃ may use a chat-based communication interface of chat application 112₃ to send information (e.g., a sensor status of a sensor, an indicator that a threshold of a sensor has been satisfied, an actuator status of an actuator, a measurement from a monitor, a toner or paper status of a printer, an available storage status of a digital video recorder, an indication of a potential security breach of a home network, an indicator of a status or reading of a vehicle information and control system, or the like) to chat application 112₁ via communication channel 140₂ for providing the information to human entity 110₁. It will be appreciated that the foregoing examples are merely a few of the various ways in which communication channel 140₂ between the chat application 112₁ of user device 111₁ and the chat application 112₃ of device entity 110₃ may be used to support chat-based communication between human entity 110₁ and device entity 110₃.

The communication channel 140₂ between the chat application 112₁ of user device 111₁ and the chat application 112₃ of device entity 110₃ may also traverse entity representatives 120₁ and 120₃ and chat-based core 130, one or more of which may perform various functions in support of chat-based communication between human entity 110₁ and device entity 110₃ via communication channel 140₂. For example, for a communication from human entity 110₁ to device entity 110₃, the communication may be routed via a path including entity representative 120₁, chat-based core 130, and entity representative 120₃, one or more of which may process the communication to convert the communication from a format supported by human entity 110₁ (e.g., natural language) to a format supported by device entity 110₃ (e.g., a machine-based format which is expected to vary across different types of devices). For example, for a communication from device entity 110₃ to human entity 110₁, the communication may be routed via a path including entity representative 120₃, chat-based core 130, and entity representative 120₁, one or more of which may process the communication to convert the communication from a format supported by device entity 110₃ (e.g., a machine-based format, which is expected to vary across different types of devices) to a format supported by human entity 110₁ (e.g., natural language). The entity representatives 120₁ and 120₃ and chat-based core 130 may operate to provide these types of conversions under various conditions in support of communications exchanged between human entity 110₁ and device entity 110₃ via communication channel 140₂.

For example, where device entity 110₃ is a video server, the human-device interaction between human entity 110₃ and the video server may proceed as follows: (1) human entity 110₁ may select a representation of the video server via chat application 112₁ and enter and submit, via a chat-based communication interface of chat application 112₁, a request such as “I want the latest movie to win a best picture award?”; (2) the request is propagated toward the chat application 112₃ of video server via communication channel 140₂, (3) one or more of entity representative 120₁, chat-based core 130, or entity representative 120₃ operates on the request in order to convert the request into a device language supported by the video server (e.g., REQUEST: MOVIE, METADATA: AWARD, BEST PICTURE WINNER, LATEST) before the request is received by the video server, (4) the chat application 112₃ of video server receives the request and passes the request to a video identification and retrieval module of the video server via a chat-based communication interface of chat application 112₃, (5) the video identification and retrieval module of the video server identifies and retrieves the requested movie and provides the requested movie to chat application 112₃ of the video server, via a chat-based communication interface of chat application 112₃, for propagation toward user device 111₁ via communication channel 140₂ for making the movie accessible to human entity 110₁, and (6) chat application 112₁ of user device 111₁ receives movie content from the video server via communication channel 140₂ and makes the video content accessible to human entity 110₁ (e.g., via the chat-based communication interface of chat application 112₁ or by passing the video content to one or more other modules on user device 111₁).

For example, where device entity 110₃ is a sensor, the human-device interaction between human entity 110₃ and the sensor may proceed as follows: (1) human entity 110₁ may select a representation of the sensor via chat application 112₁ on user device 111₁ and enter and submit, via a chat-based communication interface of chat application 112₁, a query such as “what is the latest reading?”, (2) the query is propagated toward the chat application 112₃ of sensor via communication channel 140₂, (3) one or more of entity representative 120₁, chat-based core 130, or entity representative 120₃ on the communication channel 140₂ operates on the query in order to convert the query into a formatted query using device language supported by the sensor (e.g., REQUEST: DEVICE READING, LATEST) before providing the query to the sensor, (4) the chat application 112₃ of sensor receives the formatted query and passes the formatted query to a sensor reading module of the sensor via a chat-based communication interface of chat application 112₃, (5) the sensor reading module of the sensor identifies and obtains the requested sensor reading and provides a formatted sensor reading response to chat application 112₃ of the sensor, via a chat-based communication interface of chat application 112₃, for propagation toward user device 111₁ via communication channel 140₂ for making the requested sensor reading accessible to human entity 110₁, (6) one or more of entity representative 120₃, chat-based core 130, or entity representative 120₁ operates on the formatted sensor reading response in order to convert the formatted sensor reading response into a natural language sensor reading response before providing the sensor reading to human entity 110₁, and (7) chat application 112₁ of user device 111₁ receives the natural language sensor reading response via communication channel 140₂ and presents the natural language sensor response to human entity 110₁ via the chat-based communication interface of the chat application 112₁.

For example, where device entity 110₃ is a printer, the human-device interaction between human entity 110₃ and the printer may proceed as follows: (1) human entity 110₁ may select a representation of the printer via chat application 112₁ on user device 111₁ and enter and submit, via a chat-based communication interface of chat application 112₁, a request such as “please print document1” while also attaching a copy of document1, (2) the request is propagated toward the chat application 112₃ of printer via communication channel 140₂, (3) one or both of chat-based core 130 and entity representative 120₃ operates on the request in order to convert the request into a formatted request using device language supported by the printer before providing the request to the printer, (4) the chat application 112₃ of printer receives the formatted request and associated document and passes the formatted request and associated document to a print control module of the printer via a chat-based communication interface of chat application 112₃, (5) the print control module of the printer initiates printing of the document and, when printing is complete, provides a formatted print status response to chat application 112₃ of the printer, via a chat-based communication interface of chat application 112₃, for propagation toward user device 111₁ via communication channel 140₂ for making the print status accessible to human entity 110₁, (6) one or both of entity representative 120₃ or chat-based core 130 operates on the formatted print status response in order to convert the formatted print status response into a natural language print status response before providing the print status to human entity 110₁, and (7) chat application 112₁ of user device 111₁ receives the natural language print status response and presents the natural language print status response to human entity 110₁ via the chat-based communication interface of the chat application 112₁.

It will be appreciated that the foregoing examples represent merely a few of the various ways in which chat-based system 100 may support human-device interactions between human entity 110₁ and device entity 110₃ via the communication channel 140₂ between chat application 112₁ and chat application 112₃.

The chat-based system 100 supports human-program interaction between human entity 110₁ and entity 110₄, which is a program entity. The program entity 110₄ may be any type of program on any type of device with which user device 111₁ of human entity 110₁ may communicate. For example, program entity 110₄ may be an online ordering program (e.g., an e-commerce shopping program, an order and payment processing program of a restaurant, or the like), an online service provider program (e.g., a program of a telecommunications service provider, a program of an electricity provider, or the like), a program available on a network device or datacenter device (e.g., an application hosted in the network or datacenter), an ordering program of a business, a concierge program of a hotel, a taxi scheduling program of a taxi company, a vehicle information and control program of a vehicle, or the like. The program entity 110₄ includes a chat application 112₄. The chat-based system 100 supports establishment of a communication channel 140₄ between the chat application 112₄ of user device 111₁ and the chat application 112₄ of program entity 110₄ running on device 111₄). The chat application 112₄ supports a chat-based communication interface via which program entity 110₄ may provide information for propagation to human entity 110₁ and via which program entity 110₄ may receive information from human entity 110₁. The chat-based communication interface may provide an interface between the chat application 112₄ (including the communication channel 140₄ established with chat application 112₃) and one or more modules or elements of program entity 110₄ (e.g., modules or elements configured to process information received via communication channel 140₃, modules or elements configured to provide information for transmission via communication channel 140₃, or the like, as well as various combinations thereof). The chat application 112₄ may have associated therewith a contact list 113₄, which includes a list of other entities 110 that are associated with program entity 110₄ via chat application 112₄ (illustratively, human entity 110₁). The chat application 112₄ is not expected to include a display interface or component, as the program entity 110₄ is expected to participate in chat-based communication via communication channel 140₃ independent of any human interaction. The communication channel 140₃ between the chat application 112₁ of user device 111₁ and the chat application 112₄ of program entity 110₄ may support various types of communication between human entity 110₁ and program entity 110₄, where the types of communication supported may depend on the program type of program entity 110₄. The communication channel 140₃ between the chat application 112₁ of user device 111₁ and the chat application 112₄ of program entity 110₄ may also traverse entity representatives 120₁ and 120₄ and chat-based core 130, one or more of which may perform various functions in support of communication between human entity 110₁ and program entity 110₄ via communication channel 140₄. The human-program interaction between human entity 110₁ and program entity 110₄ via communication channel 140₄ is expected to be similar to the human-device interaction human entity 110₁ and device entity 110₃ via communication channel 140₃ and, thus, detailed examples are omitted. For example, human entity 110₁ may use a chat-based communication interface of chat application 112₁ to request and receive reservations from a restaurant reservation scheduling program, a dentist office patient scheduling program may use a chat-based communication interface of chat application 112₄ to request and receive confirmation that human entity 110₁ intends on keeping his or her scheduled appointment, and so forth. It will be appreciated that such programs will be executing on devices (e.g., servers, physical resources hosting VMs, computers, or the like) and, thus, that various embodiments discussed herein with respect to human-device interaction between human entity 110₁ and device entity 110₃ also may be used for human-program interaction between human entity 110₁ and program entity 110₄. Namely, in at least some embodiments, human-program interaction between human entity 110₁ and program entity 110₄ also may be considered to be human-device interaction between human entity 110₁ and a device hosting the program entity 110₄.

The chat-based system 100 also may be configured to support other communication interaction types between human entity 110₁ and other types of non-human entities. For example, chat-based system 100 also may be configured to support human-process interaction between human entity 110₁ and one or more processes (e.g., a digital conference, a collaborative session, or the like). For example, chat-based system 100 also may be configured to support human-organization interaction between human entity 110₁ and one or more organizations (e.g., a business, a not-for-profit organization, an educational organization, or the like). The chat-based system 100 also may be configured to support other communication interaction types between human entity 110₁ and other types of non-human entities. For example, other types of non-human entities may include locations (e.g., a store, a restaurant, a library, or the like), objects, or the like. It will be appreciated that interaction by human entity 110₁ with such non-human entities may be performed using devices associated with the non-human entities, as communication between human entity 110₁ and such non-human entities will be performed using communication channels established between the chat application 112₁ running on user device 111₁ of human entity 110₁ and chat applications running on devices associated with the non-human entities or chat applications integrated or associated with programs on devices associated with the non-human entities, respectively. Accordingly, various embodiments discussed herein with respect to human-device interaction between human entity 110₁ and device entity 110₃ and human-program interaction between human entity 110₁ and program entity 110₄ also may be used for other communication interaction types between human entity 110₁ and other types of non-human entities. Namely, in at least some embodiments, other communication interaction types between human entity 110₁ and other types of non-human entities also may be considered to be human-device interaction between human entity 110₁ and a device that is associated with the non-human entity or human-program interaction between human entity 110₁ and a program that is associated with the non-human entity.

The chat-based system 100 supports identification of entities 110 to chat-based core 130 such that the entities 110 are available for association with other entities 110 of chat-based system 100. For example, human entities 110 (illustratively, human entities 110₁ and 110₂, as well as various other human entities) may register with chat-based core 130 (e.g., by establishing an account with chat-based core 130). Similarly, for example, non-human entities 110 (illustratively, device entity 110₃ and program entity 110₄, as well as various other non-human entities) may register with chat-based core 130 or may be registered with chat-based core 130 (e.g., such as where a non-human entity is registered with chat-based core 130 by a human but may then participate in chat-based communications independent of human interaction). In this manner, various entities 110 become discoverable within chat-based system 100 and, thus, associations supporting various communication interactions types may be established between entities 110 as discussed herein.

The chat-based system 100, as discussed above, supports association of entities 110 with human entity 110₁ via chat application 112₁ and, similarly, supports establishment of communication channels 140 between chat application 112₁ of user device 111₁ of human entity 110₁ and chat applications of devices or programs associated with entities 110 that are associated with human entity 110₁ via chat application 112₁. As discussed above, entities 110 that are associated with human entity 110₁ via chat application 112₁ may be associated with human entity 110₁ via a contact list 113₁ of chat application 112₁ for human entity 110₁ (and, similarly, via corresponding contact lists of chat applications of the entities) The association of entities 110 with human entity 110₁ or disassociation of entities 110 from human entity 110₁ (e.g., via addition to or removal of entities 110 from the contact list 113₁ of the chat application 112₁) may be performed manually by human entity 110₁ via chat application 112₁ or automatically by chat-based system 100 based on context information. The establishment of communication channels 140 between chat application 112₁ of user device 111₁ of human entity 110₁ and chat applications of devices or programs associated with entities 110 may be performed, when chat application 112₁ is invoked on user device 111₁, for any entities 110 already associated with human entity 110₁ (e.g., based on entities already included in the contact list 113₁ of the chat application 112₁). For example, chat-based core 130 may be configured to maintain the contact list 113₁ of chat application 112₁ and, based on detection that chat application 112₁ has been invoked on user device 111₁, to provide the contact list 113₁ to chat application 112₁ for use by chat application 112₁ in establishing communication channels 140 between chat application 112₁ of user device 111₁ of human entity 110₁ and entities 110 on the contact list 113₁ of chat application 112₁. The establishment or termination of communication channels 140 between chat application 112₁ of user device 111₁ of human entity 110₁ and chat applications of devices or programs associated with entities 110 also may be performed at any time that chat application 112₁ is running on user device 111₁ (e.g., as non-human entities 110 are dynamically added to and removed from contact list 113₁ of the chat application 112₁ for human entity 110₁ based on context). For example, chat-based core 130 may be configured to detect association of a new entity 110 with human entity 110₁ or disassociation of an existing entity 110 from human entity 110₁, update the contact list 113₁ of chat application 112₁ to add the new entity 110 or remove the existing entity 110, and initiate establishment of a new communication channel 140 for the new entity 110 or termination of the existing communication channel 140 of the existing entity 110.

The chat-based system 100 may be configured to support manual or automated identification of entities 110 available for association with human entity 110₁ and, similarly, may support manual or automated association of identified entities 110 with human entity 110₁ (e.g., via inclusion in contact list 113₁ of chat application 112₁).

The chat-based system 100 may support a search-based entity association capability in which the human entity 110₁ may enter and submit specific search criteria to be used by chat-based core 130 in searching for other entities 110. For example, human entity 110₁ may specify that he or she is searching for printers available at a particular location, restaurants available in a particular geographic area, a human resources program of a company for which he or she works, a banking program of a bank with which he or she maintains an account, a collaborative session related to a particular area of interest, or the like. The chat-based core 130 may use the search criteria to identify a set of potential entities 110 which satisfy the search criteria. The chat-based core 130 may then either (1) propagate search results, including indications of the potential entities 110, toward user device 111₁ for presenting the potential entities 110 to the human entity 110₁ and providing the human entity 110₁ an opportunity to explicitly accept (or not) association of one or more of potential entities 110 with the human entity 110₁ or (2) initiate automatic association of the potential entities 110 with the human entity 110₁ (e.g., via addition of the potential entities 110 to the contact list 113₁ of the chat application 112₁ of human entity 110₁). The manual or automatic association of a potential entity 110 with human entity 110₁ may trigger establishment of a communication channel 140 between chat application 112₁ of user device 111₁ of human entity 110₁ and a chat application of the associated entity 110.

The chat-based system 100 may support a context-based entity association capability in which chat-based core 130 obtains context information and determines whether to modify the entities 110 with which human entity 110₁ is associated (e.g., associating with one or more entities 110 with which human entity 110₁ is not currently associated, disassociating from one or more entities 110 with which human entity 110₁ is currently associated, or a combination thereof). The context information may include context information associated with human entity 110₁, context information associated with a potential or existing entity 110, or the like, as well as various combinations thereof. The context information associated with human entity 110₁ may represent a context of human entity 110₁, a context of user device 111₁, a context of chat application 112₁, any other context which may be associated with human entity 110₁, or the like, as well as various combinations thereof. The context information associated with human entity 110₁ may be a location of the human entity 110₁ or user device 111₁ (e.g., a geographic location, an indoor location, or the like), information communicated via one or more communication channels 140 supported by chat application 112₁ of user device 111₁ for human entity 110₁, an indication of a need or desire of human entity 110₁, or the like, as well as various combinations thereof. The context information associated with a potential or existing entity 110 may represent a context of the potential or existing entity 110, a context of a device associated with the potential or existing entity 110, or the like, as well as various combinations thereof. The context information associated with a potential entity 110 (e.g., being considered for being associated with human entity 110₁) may be a location of the potential entity 110 (e.g., a geographic location, an indoor location, or the like), a capability of the potential entity 110 (e.g., a zoom capability of a camera, a print capability of a printer, or the like), or the like, as well as various combinations thereof. The context information associated with an existing entity 110 (e.g., being considered for being disassociated from human entity 110₁) may be a location of the existing entity (e.g., a geographic location, an indoor location, or the like), a problem associated with the existing entity, or the like, as well as various combinations thereof. The context information may be provided to chat-based core 130, obtained by chat-based core 130 based on monitoring of communications exchanged via one or more communication channels 140 supported by chat application 112₁ of user device 111₁ and traversing chat-based core 130, provided to chat-based core 130 or otherwise obtained by chat-based core 130 from one or more other devices, or the like, as well as various combinations thereof. The management of entities 110 associated with human entity 110₁ may include identifying a set of potential entities 110 based on the context information and either (1) propagating indications of the potential entities 110 (for association with or disassociation from human entity 110₁) toward user device 111₁ for presenting the potential entities 110 to the human entity 110₁ and providing the human entity 110₁ an opportunity to explicitly accept (or not) association of one or more of potential entities 110 with the human entity 110₁ or disassociation of one or more of potential entities 110 from the human entity 110₁ or (2) initiating automatic association/disassociation of the potential entities 110 with/from the human entity 110₁ (e.g., via addition of the potential entities 110 to the contact list 113₁ of the chat application 112₁ of human entity 110₁ in the case of association or removal of the potential entities 110 from the contact list 113₁ of the chat application 112₁ in the case of disassociation). For example, upon detecting that the user device 111₁ of human entity 110₁ has entered a particular geographic area, chat-based core 130 may identify a list of potential entities 110 at or near the geographic area of the user device 111₁ (e.g., a concierge entity at a hotel, a receptionist entity at a dentist office, a printer entity at an office location, or the like). For example, upon detecting particular content in chat-based communication between human entity 110₁ and human entity 110₂, chat-based core 130 may identify, on the basis of the content, a list of potential entities 110 that may be of interest to human entity 110₁ (e.g., upon detecting the word “print” or some variation thereof in a chat session, chat-based core 130 may infer that human entity 110₁ has a need to print a document and, thus, may identify a list of printer entities which may be useful to human entity 110₁). The manual or automatic association of a potential entity 110 with human entity 110₁ may trigger establishment of a communication channel 140 between chat application 112₁ of user device 111₁ of human entity 110₁ and the associated entity 110. As discussed above, it will be appreciated that, although primarily described with respect to use of context information for associating a potential entity 110 with human entity 110₁ and triggering establishment of a communication channel 140 between chat application 112₁ of user device 111₁ of human entity 110₁ and the chat application of the associated entity 110, context information also may be used for disassociating an associated entity 110 from human entity 110₁ (e.g., via removal of the associated entity 110 from contact list 113) and triggering termination of the existing communication channel 140 between the chat application 112₁ of user device 111₁ of human entity 110₁ and the chat application of the existing entity 110. Accordingly, chat-based system 100 may support a dynamic contact list capability whereby associations of human entity 110₁ with other entities 110 may be updated dynamically (including addition and removal) based on context information associated with human entity 110₁ and, similarly, communication channels 140 between chat application 112₁ of user device 111₁ of human entity 110₁ and chat applications of other entities 110 may be controlled dynamically (including establishment and termination). Various embodiments of the dynamic contact list capability may be better understood by way of the following exemplary embodiments and examples.

In at least some embodiments, chat-based system 100 may be configured to, in response to one or more stimuli specified within chat-based system 100, generate a contact list identity (representing an entity 110) in the contact list 113₁ of human entity 110₁, as well as to create an associated communication channel 140 which may be used for communication between human entity 110₁ and entity 110 represented by the generated contact list identity. The stimuli may include device or program state, receipt of a message (e.g., a notification, an event, or the like), or the like, as well as various combinations thereof. The chat-based system 100 (or remote processing capabilities associated with the chat-based system 100) may then support, or even enhance, interaction by human entity 110₁ with the entity 110 that is represented by the generated contact list identity (e.g., facilitating communication between the human entity 110₁ and the entity 110, acting upon messages or information sent from human entity 110₁ to the entity 110, acting upon messages or information sent from entity 110 to human entity 110₁, or the like, as well as various combinations thereof).

In at least some embodiments, for example, dynamic contact list identities may be generated in the contact list 113₁ of human entity 110₁ according to the location of human entity 110₁. For example, a contact list identity named “receptionist” (e.g., a device or program that is configured to provide “receptionist” functions) might appear on contact list 113₁ of human entity 110₁ when human entity 110₁ enters the reception area of a building, such that the chat-based communication interface of chat application 112₁ may be used by human entity 110₁ to send to the “receptionist” entity a request for directions to a particular location in the building, and the chat-based communication interface of the chat application of the “receptionist” entity may be used by the “receptionist” entity to send the requested directions to human entity 110₁ (where the information is exchanged via the communication channel 140 established between the chat application 112₁ and the chat application of the “receptionist” entity). For example, a contact list identity named “concierge” (e.g., a device or program that is configured to provide “concierge” functions) might appear on contact list 113₁ of human entity 110₁ when human entity 110₁ enters a hotel lobby area, such that the chat-based communication interface of chat application 112₁ may be used by human entity 110₁ to send to the “concierge” entity a request for a reservation at a local Italian restaurant, and the chat-based communication interface of the chat application of the “concierge” entity may be used by the “concierge” entity to send to the human entity 110₁ directions to the Italian restaurant at which the “concierge” entity made reservations on behalf of the human entity 110₁ (where the information is exchanged via the communication channel 140 established between the chat application 112₁ and the chat application of the “concierge” entity). For example, a contact list identity named “printer” might appear on contact list 113₁ of human entity 110₁ when human entity 110₁ enters his or her work location, such that the chat-based communication interface of chat application 112₁ may be used by human entity 110₁ to send to the “printer” entity document and a request for the document to be printed, and the chat-based communication interface of the chat application of the “printer” entity may be used by the “printer” entity to send to the human entity 110₁ directions to the location of the printer at which the document was printed for the human entity 110₁ (where the information is exchanged via the communication channel 140 established between the chat application 112₁ and the chat application of the “printer” entity). For example, a contact list identity named “cafeteria” might appear on contact list 113₁ of human entity 110₁ when human entity 110₁ enters a designated location, such that (1) the chat-based communication interface of chat application 112₁ may be used by human entity 110₁ to send a request for a menu, (2) the chat-based communication interface of the chat application of the “cafeteria” entity may be used by the “cafeteria” entity to provide the requested menu to the human entity 110₁, (3) the chat-based communication interface of chat application 112₁ may be used by human entity 110₁ to send an order for food listed on the menu, (4) the chat-based communication interface of the chat application of the “cafeteria” entity may be used by the “cafeteria” entity to request payment for the food ordered by human entity 110₁, (5) the chat-based communication interface of chat application 112₁ may be used by human entity 110₁ to provide payment for the food ordered by human entity 110₁, and (6) the chat-based communication interface of the chat application of the “cafeteria” entity may be used by the “cafeteria” entity to direct the human entity 110₁ to a location where the food may be picked up (where the information is exchanged via the communication channel 140 established between the chat application 112₁ and the chat application of the “cafeteria” entity).

In at least some embodiments, for example, dynamic contact list identities may be generated in the contact list 113₁ of human entity 110₁ according to association of human entity 110₁ with a process. For example, a contact list identity named “voice conference” might appear on contact list 113₁ of human entity 110₁ when human entity 110₁ joins the voice conference, such that a communication channel 140 established between the chat application 112₁ and the chat application of the “voice conference” entity (e.g., a device or program that is associated with the voice conference) may be used by the human entity 110₁ and the “voice conference” entity to perform various functions within the context of the voice conference (e.g., to request and control sending of an invite for an additional party to join the voice conference, to request a copy of the slides being discussed and have the requested slides be retrieved from a server and delivered to the chat application 112₁ for presentation to human entity 110₁, or the like). For example, a set of contact list identities associated with functions supporting a multi-party remote collaboration session (e.g., “attendance”, “minutes”, “slides”, “video” or the like, which, for example, might be organized under a higher-level entity called “collaborative support”) might appear on contact list 113₁ of human entity 110₁ when human entity 110₁ joins the multi-party remote collaboration session, such that communication channels 140 established between the chat application 112₁ and chat applications of the “collaborative support” entities (e.g., devices or programs associated with the multi-party remote collaboration session) may be used by the human entity 110₁ and the “collaborative support” entities to perform various functions within the context of the multi-party remote collaboration session (e.g., to request a copy of the slides being discussed and have the requested slides be retrieved from a server and delivered to the chat application 112₁ for presentation to human entity 110₁, to request a video feed of a physical location where parties to the multi-party remote collaboration session are located and have the video feed delivered to the chat application 112₁ for presentation to human entity 110₁, or the like).

In at least some embodiments, chat-based system 100 may be configured to, in response to one or more stimuli specified within chat-based system 100, remove an existing contact list identity (representing an entity 110 with which human entity 110₁ is associated) from the contact list 113₁ of human entity 110₁, as well as to terminate an existing communication channel 140 previously established for communication between human entity 110₁ and the entity 110 represented by the existing contact list identity. The stimuli may include device or program state, receipt of a message (e.g., a notification, an event, or the like), or the like, as well as various combinations thereof. This embodiment may be better understood by further considering the examples discussed above in conjunction with dynamic generation of contact list identities. For example, the “receptionist” entity may be removed from the contact list 113₁ based on a determination that the human entity 110₁ has left the building, the “concierge” entity may be removed from the contact list 113₁ based on a determination that the human entity 110₁ has left the lobby area of the hotel, the “printer” entity may be removed from the contact list 113₁ based on a determination that the human entity 110₁ has left the building, the “cafeteria” entity may be removed from the contact list 113₁ based on a determination that the human entity 110₁ has left the building, the “voice conference” entity may be removed from the contact list 113₁ based on a determination that the human entity 110₁ has left the voice conference, the “collaborative support” entities may be removed from the contact list 113₁ based on a determination that the human entity 110₁ has left the multi-party remote collaboration session, and so forth.

In at least some embodiments, chat-based system 100 may be configured to support associations between contacts of an entity 110 (e.g., between contacts included in the contact list 113₁ of chat application 112₁ of human entity 110₁). The associations between contacts of human entity 110₁ may be established or removed one or more of manually responsive to input from human entity 110₁, automatically by chat-based core 130 or entity representatives 120 (e.g., based on knowledge or inference of relationships or interfaces, or knowledge or inference of lack of relationships or interfaces, between the contacts), or the like, as well as various combinations thereof. For example, a “home” contact may be associated with, and configured to act as an interface to, a collection of more specialized contacts (e.g., a “computer” contact, an “entertainment system” contact, a “smart device” contact, or the like). For example, a “work” contact may be associated with, and configured to act as an interface to, a collection of more specialized contacts (e.g., a “printer” contact, a “copier” contact, a “fax machine” contact, a “cafeteria” contact, a “human resources” contact, one or more co-worker contacts, or the like). For example, a “car” contact may be associated with, and configured to act as an interface to, a collection of more specialized contacts (e.g., an “engine” contact, “a climate control” contact, a “radio” contact, or the like). The associations between contacts of human entity 110₁ may be used in various ways to support interactions between human entity 110₁ and various other entities 110.

The chat-based system 100 may support a single login authentication capability for human entity 110₁ via the chat application 112₁, whereby human entity 110 is only required to login chat application 112₁ in order to access other entities 110 associated with human entity 110₁. For example, when human entity 110₁ invokes the chat application 112₁, human entity 110₁ may be prompted to enter authentication information (e.g., login and password) which may then be sent to chat-based core 130 for use in authenticating the human entity 110₁ (namely, for determining whether human entity 110₁ is permitted to access chat application 112₁). Here, authentication of the human entity 110₁ to access other entities 110 may have been previously established, or may be performed by chat-based core 130 on behalf of human entity 110₁ responsive to authentication of human entity 110₁ to access chat application 112₁ (e.g., where chat-based core 130 initiates authentication with one or more of the entities 110 included in the contact list 113₁ associated with human entity 110₁). In either case, human entity 110₁ is authenticated to access the other entities 110 automatically, without requiring the human entity 110₁ to enter additional authentication information for each of the other entities 110. In other words, the authentication procedures of the chat application 112₁ allow interaction with various devices (e.g., device entity 110₃) and programs (e.g., program entity 110₄). In this manner, authentication by the human entity 110₁ for multiple other entities 110 (e.g., devices, programs, or the like) becomes seamless for human entity 110₁.

The chat application 112₁ of user device 111₁ is configured to provide various function supporting human-to-human interactions (e.g., between human entity 110₁ and human entity 110₂ via communication channel 140₁) as well as other communication interaction types, including human-device interactions (e.g., between human entity 110₁ and device entity 110₃ via communication channel 140₂) and human-program interactions (e.g., between human entity 110₁ and program entity 110₄ via communication channel 140₃). The functions typically supported by a chat application in enabling human-to-human interactions are understood and thus, are not repeated herein. It will be appreciated that at least some such functions typically supported by a chat application in enabling human-to-human interactions may be used, or adapted for use, in supporting other communication interaction types discussed herein.

The chat application 112₁ of user device 111₁ may be configured to provide one or more mechanisms via which human entity 110₁ may identify non-human entities 110 with which human entity 110₁ has associations and, thus, with which the chat application 112₁ has corresponding communication channels 140, respectively. For example, the chat application 112₁ may be configured such that human entity 110₁ may identify associated non-human entities 110 via one or more menus or other controls available from chat application 112₁. For example, the chat application 112₁ may be configured such that associated non-human entities 110 are represented within, and, thus, may be identified from, the contact list 113₁ of the chat application 112₁ (e.g., using an entity identifier of the non-human entity 110, similar to the manner in which human contacts (or “buddies”) of human entity 110₁ might be represented within contact list 113). The contact list 113₁ may be a common contact list including both human entities 110 and non-human entities 110 with which human entity 110₁ is associated (e.g., arranged alphabetically or based on status irrespective of whether the contact is a human entity 110 or a non-human entity 110, organized into subgroups based on the contacts being human entities 110 or non-human entities 110 and then arranged alphabetically or based on status, or the like), a separate contact list including only non-human entities 110 with which human entity 110₁ is associated (e.g., where human entities 110 with which human entity 110₁ is associated may be maintained in a separate contact list), or the like. In the case of dynamic addition or removal of non-human entities 110, the contact list 113₁ may be automatically updated to display or not display non-human entities 110 as the non-human entities 110 are added or removed, respectively (in other words, non-human entities 110 may automatically appear on and disappear from contact list 113₁ as the non-human entities 110 are added or removed, respectively). The chat application 112₁ may be configured to provide other mechanisms via which human entity 110₁ may identify non-human entities 110 with which human entity 110₁ has associations.

The chat application 112₁ of user device 111₁ may be configured to provide one or more chat-based communication interfaces via which human entity 110₁ may interact with non-human entities 110 with which human entity 110₁ has associations. The manner in which human entity 110₁ uses a chat-based communication interface of chat application 112₁ to initiate communication with an associated non-human entity 110 may depend on the manner in which human entity 110₁ identifies the associated non-human entity 110 via chat application 112₁ (e.g., via one or more menu or other control selections, from displayed contact list 113, or the like). For example, human entity 110₁ may select the associated non-human entity 110 from a drop-down menu, select the associated non-human entity 110 from contact list 113₁ where the associated non-human entity 110 is displayed in the contact list 113, or the like. For example, selection of the associated non-human entity 110 may trigger opening of a window or dialog box via which the human entity 110 may initiate communications with the associated non-human entity 110 (e.g., typing text, attaching content or the like), may trigger opening of a menu via which the human entity 110 may initiate communications with the associated non-human entity 110, or the like, as well as various combinations thereof. The manner in which human entity 110₁ is made aware of a communication from an associated non-human entity 110 via a chat-based communication interface of chat application 112₁ may depend on the configuration of the chat application 112₁. For example, notification of receipt of the communication from the associated non-human entity 110 may be presented to the human entity 110₁ by the chat application 112₁ via one or more interfaces of chat application 112₁, by triggering opening of one or more windows outside of the context of chat application 112₁, via invocation of one or more programs on user device 111₁, or the like, as well as various combinations thereof. For example, notification of receipt of the communication from the associated non-human entity 110 may be presented to the human entity 110₁ by the chat application 112₁ via a presentation interface of user device 111₁ (e.g., such that the human entity 110₁ may then access the communication), the communication from the associated non-human entity 110 to the human entity 110₁ may be presented to the human entity 110₁ by the chat application 112₁ (e.g., similar presentation of chat messages from human entities in typical chat applications), information provided from the associated non-human entity 110 to human entity 110₁ may be presented to the human entity 110₁ via invocation of one or more associated programs or applications on user device 111₁ (e.g., launching a word processing application for presentation of a text document provided in the communication from the associated non-human entity 110, launching an audio player for playout of audio content provided in the communication from the associated non-human entity 110, launching a video player for playout of video content provided in the communication from the associated non-human entity 110, or the like), or the like, as well as various combinations thereof.

The chat applications 112₃ and 112₄ may be configured to operate in a manner similar to chat application 112₁, although, as discussed above, it is expected that, rather than being displayed (such as chat applications 112₁ and 112₂), chat applications 112₃ and 112₄ may run on device entity 110₃ and device 111₄, respectively. The chat-based communication interfaces of chat applications 112₃ and 112₄ may include any suitable software and/or hardware based interfaces which enable interaction between the chat applications 112₃ and 112₄ and software and/or hardware components or elements of the device entity 110₃ and the device 111₄ on which chat applications 112₃ and 112₄ are executing, respectively, as discussed above.

The entity representatives 120 associated with entities 110 are configured to provide various functions, at least some of which have been discussed above. For example, an entity representative 120 associated with a non-human entity 110 may provide or support one or more of registration functions for enabling the non-human entity 110 to register with chat-based core 130 (and, thus, to be identified by and associated with human entity 110₁), communication channel control functions for establishing and maintaining one or more communication channels 140 for chat-based communication between the non-human entity 110 and one or more other entities 110 (illustratively, communication channel 140₂ for chat-based communication with human entity 110₁, as well as any other suitable communication channels 140), communication control functions for controlling communication between the non-human entity 110 and one or more other entities 110 via one or more communication channels 140, translation functions for translating messages and information between the format(s) supported by the non-human entity 110 and the format(s) supported by one or more other entities 110 with which non-human entity 110 may communicate via one or more communication channels 140, enhanced processing functions for supporting enhanced processing which may be provided by the non-human entity 110 based on communication between the non-human entity 110 and one or more other entities 110 via one or more communication channels 140, or the like, as well as various combinations thereof. The translation functions may include natural language recognition capabilities for allowing chat-based communications to be translated between human-understandable text and formats supported by non-human entities 110. Similarly, for example, an entity representative 120 associated with a human entity 110 (illustratively, entity representative 120₁ associated with human entity 110₁) may be configured to provide similar functions for supporting communications between the human entity 110 and one or more non-human entities 110. The entity representatives 120 may be configured to support various types of activities and services which may be provided based on communication between entities 110 via communication channels 140. The entity representatives 120 also may be configured to include various modules or provide various functions primarily depicted and described herein as being performed by chat applications 112 operating on endpoint devices (e.g., providing a differently or more distributed deployment of chat applications 112).

The chat-based core 130 is configured to provide various functions, at least some of which have been discussed above. For example, chat-based core 130 may provide or support one or more of registration functions for enabling the entities 110 to register with chat-based core 130 (and, thus, to be identified by and associated with other entities 110), communication channel control functions for establishing and maintaining communication channels 140 between chat applications 112 of entities 110, communication control functions for controlling communication between entities 110 via associated communication channels 140, translation functions for translating messages and information between different formats supported by different entities 110, enhanced processing functions for supporting enhanced processing which may be provided based on communication between entities 110 via communication channels 140, or the like, as well as various combinations thereof. The translation functions may include natural language recognition capabilities for allowing chat communications to be translated between human-understandable text and formats supported by non-human entities 110. The chat-based core 130 may be configured to support various types of activities and services which may be provided based on communication between entities 110 via communication channels 140. The chat-based core 130 also may be configured to include various modules or provide various functions primarily depicted and described herein as being performed by chat applications 112 operating on endpoint devices (e.g., providing a differently or more distributed deployment of chat applications 112).

The communication channels 140 established between chat application 112₁ of human entity 110₁ and chat applications 112 of other entities 110 support chat-based communications between human entity 110₁ and the other entities 110, respectively. The communication channels 140 may be established and maintained using chat-based functions. The communication channels 140 may be accessed via chat-based communication interfaces supported by the chat applications 112 between which the communication channels 140 are established. The communication channels 140 support various communication interaction types as discussed above. The communication channels 140 support chat-based or chat-like communication between human entity 110₁ and other entities 110. The communication channels 140 provide communication paths for various types of messages and information which may be exchanged between entities 110 (e.g., requests and responses, commands and responses, event notifications, content delivery, or the like, as well as any other types of messages or information which may be propagated via the communication channels 140). The communication channels 140 may support various types of activities and services which may be provided based on communication between human entity 110₁ and other entities 110 via communication channels 140. The communication channels 140 may be supported using any suitable underlying communication networks (e.g., wireline networks, wireless networks, or the like) which, it will be appreciated, may depend on the context within which the communication channels 140 are established. As indicated above, although the communication channels 140 are primarily depicted and described as being established between the chat application 112₁ of user device 111₁ of human entity 110₁ and the chat applications 112 of other entities 110, the communication channels 140 also may be considered to be established between the user device 111₁ of human entity 110₁ and devices hosting the chat applications 112 of the other entities 110, between the user device 111₁ of human entity 110₁ and programs associated with the chat applications 112 of the other entities 110, or the like.

The chat-based system 100 may be configured to support enhanced processing for communications exchanged via communication channels 140. As noted above, enhanced processing for communications exchanged via communication channel 140 may be provided by one or more of the entities 110 participating in the communication, one or more entity representatives 120 of the one or more of the entities 110 participating in the communication, chat-based core 130, or a combination thereof. For example, enhanced processing for communications exchanged via a given communication channel 140 may include time-based acceleration or deceleration of actions based on context (e.g., delaying printing of a document by a printer until the person is detected as being at or near the location of the printer, accelerating processing of a food order at a restaurant based on a determination that the person has arrived at the restaurant ahead of schedule, or the like), initiating or terminating one or more entity associations (e.g., adding a new entity to a contact list or removing an entity from a contact list) based on information exchanged via the given communication channel 140 (e.g., automatically initiating addition of a home security control entity for securing a home of a user based on a chat message indicative that the user is away from home, automatically initiating removal of a printer entity for a work printer of a user based on a chat message indicative that the user is working from home, or the like), initiating one or more messages to one or more existing or new entities via one or more existing or new communication channels based on information exchanged via the given communication channel 140 (e.g., automatically initiating a message to a taxi scheduling entity for scheduling a taxi based on detection that a concierge entity has made a reservation with a restaurant entity, automatically initiating a message to a credit score entity based on detection that a banking entity requires credit scope information, or the like), automatically performing one or more actions outside of the context of the chat application based on context information determined from communications exchanged via the given communication channel 140 (e.g., initiating or terminating a phone call, launching or terminating a program, or the like), or the like, as well as various combinations thereof.

The chat-based system 100 may be configured to support higher level system enhancements for chat-based system 100. For example, chat-based system 100 may be configured to generate various contexts for various chat sessions and to use the context information to control execution of chat-based system 100 (e.g., context information about past interactions among chat participants via chat-based system 100 can be used by chat-based system 100 to fine-tune various aspects of chat-based system 100, such as the form of interaction between chat participants, presentation of data to chat participants, or the like, as well as various combinations thereof).

The chat-based system 100 may be configured to support data analytics functions. In at least some embodiments, data from one or more entities 110 may be analyzed to develop a model or representation of the context in which a chat(s) occurs. The data may include chat messages, data other than chat-based data, or a combination thereof. The data analytics may be performed locally (e.g., using one or more local modules), remotely (e.g., using one or more remote modules), or a combination thereof. The context may then be utilized locally (e.g., by one or more local modules), remotely (e.g., by one or more remote modules), or a combination thereof. The context may be used for various purposes (e.g., to handle chat messages, to act in response to chat messages, or the like, as well as various combinations thereof). The data analytics functions may be provided by chat-based core 130, entity representatives 120, entities 110, or the like, as well as various combinations thereof. The use of context in this manner permits integration of data analytics into a wide range of communication functions and behaviors.

As discussed above, while chat-based system 100 is primarily depicted and described with respect to supporting multiple communication interaction types for a human entity, chat-based system 100 may be configured to support communication between non-human entities, where the non-human entities may include devices, programs, processes, organizations, or the like. An example is depicted in FIG. 1, where a communication channel 141 is established between chat application 112₃ of device entity 110₃ and chat application 112₄ of program entity 110₄. The establishment and use of communication channel 141 may be similar to establishment and use of communication channels 140. For example, where device entity 110₃ is a printer located in an office of an employee of a company and program entity 110₄ is a human resources program of the company, the human resources program may propagate a benefits agreement that needs to be signed by the employee to the printer, via the communication channel 141, such that the benefits agreement is automatically printed and readily available for signature by the employee. For example, where device entity 110₃ is a security camera and program entity 110₄ is a security monitoring program, the security monitoring program may propagate a reconfiguration message to the security camera, via the communication channel 141, such that the security camera is automatically reconfigured based on the needs of the security program. For example, where device entity 110₃ is a content server and program entity 110₄ is a personal content scheduling program of a user that is running on a device (e.g., computer, digital video recorder, or the like), the personal content scheduling program may propagate a content request message to the content server via the communication channel 141 in order to request retrieval of a content item predicted by the personal content scheduling program to be of interest to the user, and the content server may provide the requested content item to the personal content scheduling program for storage on the device on which the personal content scheduling program is running. It will be appreciated that, although primarily depicted and described with respect to a specific communication interaction type between specific types of non-human entities (namely, device-program communications), chat-based system 100 may be configured to support various other communication interaction types between various other combinations of non-human entities (e.g., device-device communications between devices, program-program communications between programs, device-process communications between a device and a process, program-process communications between a program and a process, process-process communications, and so forth). For example, a power monitoring entity could use a chat-based communication channel to ask a power meter for a current reading. For example, a concierge entity could use a chat-based communication channel to ask a restaurant entity for a reservation. It will be appreciated that the foregoing examples are merely a few of the ways in which chat-based communication between multiple non-human entities may be used.

It will be appreciated that, although omitted from FIG. 1 for purposes of clarity, each chat application 112 may be implemented using any suitable concentration or distribution of functions. For example, chat applications 112 depicted in FIG. 1 may simply be chat application clients and other modules or functions of the associated chat application may be implemented in other locations (e.g., on entity representatives 120, on chat-based core 130). Various other arrangements of the functions of chat applications 112 within chat-based system 100 are contemplated.

It will be appreciated that, although omitted from FIG. 1 for purposes of clarity, each entity representative 120 may be implemented using any suitable concentration or distribution of functions (e.g., providing the functions of an entity representative 120 on one or more devices associated with the entity representative 120, providing the functions of an entity representative 120 on one or more network devices, distributing the functions of an entity representative 120 across one or more devices associated with the entity representative 120 and one or more network devices, or the like, as well as various combinations thereof).

It will be appreciated that, although omitted from FIG. 1 for purposes of clarity, chat-based core 130 may be implemented in any suitable manner (e.g., on one or more dedicated servers, using one or more sets of virtual resources hosted within one or more networks or datacenters, or the like, as well as various combinations thereof).

It will be appreciated that, although primarily depicted and described with respect to embodiments in which chat application 112₁ is configured to support human-to-human communication as well as other communication interaction types, in at least some embodiments the chat application 112₁ may be configured only for interaction between human entity 110₁ and non-human entities 110. In other words, the chat application 112₁ may be dedicated for supporting various communication interaction types involving communication between human entity 110₁ and non-human entities 110, thereby providing one or more of a device access and use capability, a program access and use capability, or the like, as well as various combinations thereof.

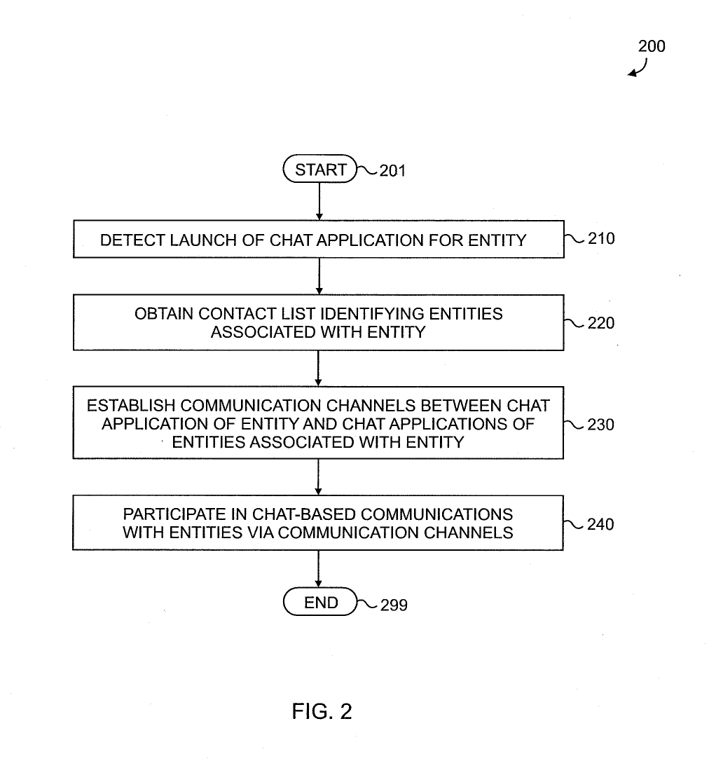

FIG. 2 depicts an exemplary embodiment of a method for supporting chat-based communications for multiple communication interaction types. It will be appreciated that, although primarily depicted and described from the perspective of an entity (or a device supporting communications by the entity), the execution of at least a portion of the steps of method 200 also may include various actions which may be performed by other elements (e.g., other entities, entity representatives of the entities, a chat-based core, or the like, as well as various combinations thereof). It will be appreciated that, although primarily depicted and described as being performed serially, at least a portion of the steps of method 200 may be performed contemporaneously or in a different order than as presented in FIG. 2. At step 201, method 200 begins. At step 210, the launch of a chat application for an entity is detected. The entity may be a human entity or a non-human entity. At step 220, a contact list, identifying entities associated with the entity, is obtained. The entities may include one or more human entities, one or more non-human entities, or combinations thereof. At step 230, communication channels are established between the chat application of the entity and chat applications of the entities identified in the contact list. At step 240, the entity participates in chat-based communications with entities identified in the contact list via the communication channels established between the chat application of the entity and the chat applications of the entities identified in the contact list. At step 299, method 200 ends. It will be appreciated that various functions depicted and described within the context of FIG. 1 may be provided within the context of method 200 of FIG. 2.

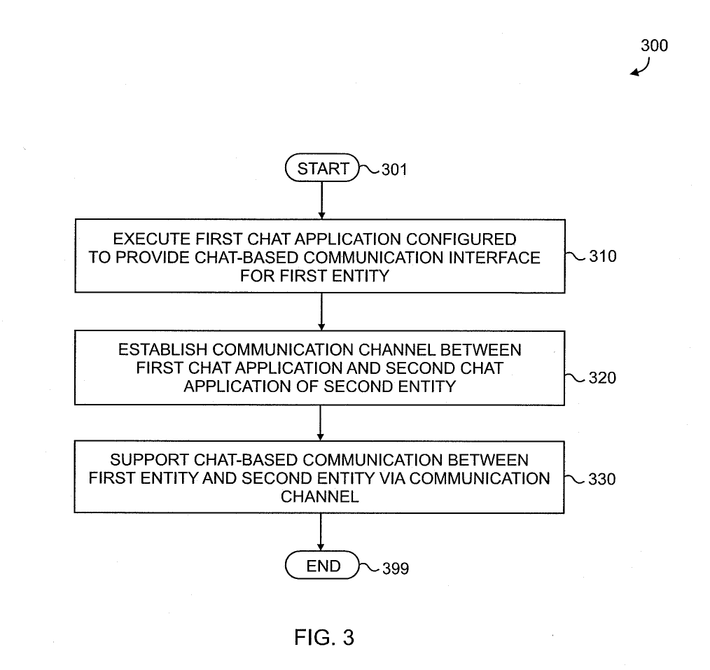

FIG. 3 depicts an exemplary embodiment of a method for supporting chat-based communications. It will be appreciated that, although primarily depicted and described from the perspective of an entity (or a device supporting communications by the entity), the execution of at least a portion of the steps of method 300 also may include various actions which may be performed by other elements (e.g., other entities, entity representatives of the entities, a chat-based core, or the like, as well as various combinations thereof). It will be appreciated that, although primarily depicted and described as being performed serially, at least a portion of the steps of method 300 may be performed contemporaneously or in a different order than as presented in FIG. 3. At step 301, method 300 begins. At step 310, a first chat application configured to provide a chat-based communication interface for a first entity is executed. The first chat application configured to provide the chat-based communication interface for the first entity also may be said to be invoked, or may be said to running or active. At step 320, a communication channel is established between the first chat application and a second chat application of a second entity. The second entity is a non-human entity. At step 330, chat-based communication between the first entity and the second entity is supported via the communication channel. At step 399, method 300 ends. The communication channel may be established based on a determination that the second entity is associated with the first chat application. The determination that the second entity is associated with the first chat application may be based on a determination that the second entity is included within a contact list of the first chat application. The determination that the second entity is associated with the first chat application may be performed responsive to invocation of the first chat application. The determination that the second entity is associated with the first chat application may be a dynamic detection of association of the second entity with the first chat application while the first chat application is running. The dynamic association of the second entity with the first chat application while the first chat application is running may be performed based on at least one of context information associated with the first entity or context information associated with the second entity. The context information associated with the first entity may include at least one of a location of the first entity, information from a chat-based communication of the first entity, a detected need of the first entity, or the like. The context information associated with the second entity may include at least one of a location of the second entity, a capability of the second entity, or the like. The support of chat-based communication between the first entity and the second entity via the communication channel may include propagating, toward the second chat application of the second entity via the communication channel, information entered by the first entity via the chat-based communication interface of the first chat application. The support of chat-based communication between the first entity and the second entity via the communication channel may include receiving information entered by the first entity via the chat-based communication interface of the first chat application, processing the information to convert the information into modified information (e.g., translating the information from one format to another, supplementing the information with additional information, or the like, as well as various combinations thereof), and propagating the modified information toward the second entity via the communication channel. The support of chat-based communication between the first entity and the second entity via the communication channel may include receiving information from the second entity via the communication channel and initiating propagation or presentation of the information to the first entity. The initiation of presentation of the information to the first entity may include at least one of initiating presentation of at least a portion of the information via the chat-based communication interface of the first chat application, initiating presentation of at least a portion of the information via an interface other than the chat-based communication interface of the first chat application, or the like. The support of chat-based communication between the first entity and the second entity via the communication channel may include receiving information from the second entity via the communication channel, processing the information to convert the information into modified information (e.g., translating the information from one format to another, supplementing the information with additional information, or the like, as well as various combinations thereof), and propagating the modified information toward the first entity. The communication channel may be terminated based on a determination that the second entity is no longer associated with the first chat application. The first entity may be a human entity or a non-human entity. The non-human entity may be a device, a program, or another non-human entity. The non-human entity may include a process or an organization, where the communication channel is established with a device or program associated with the process or the organization. It will be appreciated that various functions depicted and described within the context of FIG. 1 may be provided within the context of method 300 of FIG. 3.

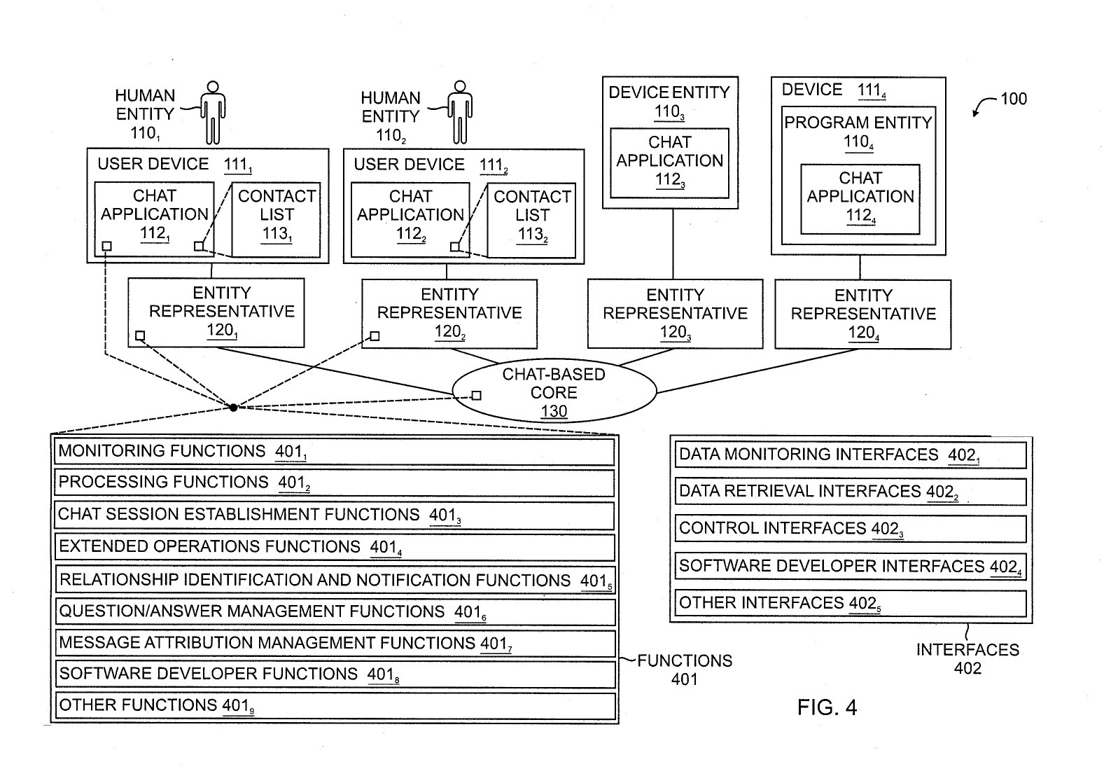

In at least some embodiments, as depicted and described herein with respect to FIG. 1 and further depicted and described with respect to FIG. 4, chat-based system 100 may be configured to support various functions, interfaces, or the like, as well as various combinations thereof.

In at least some embodiments, as depicted in FIG. 4, chat-based system 100 may be configured to support various functions 401, which may include functions that may be provided in conjunction with chat-based services, functions that may be provided independent of chat-based services, or the like, as well as various combinations thereof. For example, the functions 401 may include functions such as monitoring functions 401₁, processing functions 401₂, chat session establishment functions 401₃, extended operations functions 401₄, relationship identification and notification functions 401₅, question/answer management functions 401₆, message attribution management functions 401₇, software developer functions 401₈, other functions 401₉, or the like, as well as various combinations thereof. It will be appreciated that at least some of the functions 401 have been discussed above in conjunction with FIG. 1 and at least some of the functions 401 are discussed below. As depicted in FIG. 4, various functions 401 may be provided within chat-based system 100 in various ways (e.g., various functions 401 may be implemented on one or more of chat-based core 130, one or more entity representatives 120, one or more chat applications 112 of one or more entities 110, one or more non-human entities 110 (e.g., device entities, program entities, or the like), or the like, as well as various combinations thereof). It is noted that, although such functions 401 are primarily depicted and described as being provided within the context of chat-based system 100 of FIG. 1, at least some such functions 401 may be provided within the context of other chat-based systems or even outside of the context of a chat-based system (e.g., within various other types of contexts, environments, networks, or the like).

In at least some embodiments, as depicted in FIG. 4, chat-based system 100 may be configured to support various interfaces 402, which may include interfaces which may be used to support functions provided in conjunction with chat-based services, interfaces which may be used to support functions provided independent of chat-based services, or the like, as well as various combinations thereof. For example, the interfaces 402 may include interfaces such as data monitoring interfaces 402₁ (e.g., for monitoring data streams of various elements (e.g., networks, network devices, content servers, management systems, or the like)), data retrieval interfaces 402₂ (e.g., for retrieving location-based information from a location-based server, for retrieving social media information from social media servers, for retrieving object information from object management systems, or the like), control interfaces 402₃, software developer interfaces 402₄ (e.g., Application Programming Interfaces configured to enable software developers to interface with and develop and deploy software for chat-based system 100), other interfaces 402₅, or the like, as well as various combinations thereof. It will be appreciated that at least some of the interfaces 402 have been discussed above in conjunction with FIG. 1 and at least some of the interfaces 402 are discussed below. As depicted in FIG. 4, various interfaces 402 may be provided within chat-based system 100 in various ways (e.g., various interfaces 402 may be implemented as interfaces between one or more of chat-based core 130, one or more entity representatives 120, one or more chat applications 112 of one or more entities 110, one or more non-human entities 110 (e.g., device entities, program entities, or the like), or the like, as well as various combinations thereof). It is noted that, although such interfaces 402 are primarily depicted and described as being provided within the context of chat-based system 100 of FIG. 1, at least some such interfaces 402 may be provided within the context of other chat-based systems or even outside of the context of a chat-based system (e.g., within various other types of contexts, environments, networks, or the like).

Referring again to FIG. 1 it is noted that, as described hereinabove, in at least some embodiments, chat-based system 100 may be configured to support automatic generation of communication channels (e.g., chat session establishment functions 401₃ depicted and described with respect to FIG. 4). For example, communication channels may include a communication channel 140, a communication channel 141, or any other suitable type of communication channel. In general, a communication channel may provide a chat session supporting chat-based communication and, thus, automatic generation of a communication channel may also be considered to be automatic generation of a chat session. The use of automatic generation of a chat session obviates the need for manual initiation of the chat session which, in many cases, may be inconvenient or awkward.

The automatic generation of a chat session may be based on a recognized condition, event, or situation. The automatic generation of a chat session may be based on an existing chat session (e.g., detection of a condition, event, or other trigger based on information that is exchanged within the context of the chat session) or independent of an existing chat session (e.g., based on monitoring performed by a device that is configured to report detection of a trigger to chat-based core 130). The trigger that causes automatic generation of a chat session may be detected at various locations within chat-based system 100 (e.g., at chat-based core 130, at one or more entity representations 120, at one or more chat applications 112, at one or more devices or device entities by one or more elements other than chat applications 112 (e.g., a location tracking module of a smartphone, a calendar application of a smartphone, or the like), or the like, as well as various combinations thereof). The automatic generation of a chat session may be initiated at various locations within chat-based system 100 (e.g., at chat-based core 130, at one or more entity representations 120, at one or more chat applications 112, at one or more devices or device entities by one or more elements other than chat applications 112 (e.g., a location tracking module of a smartphone, a calendar application of a smartphone, or the like), or the like, as well as various combinations thereof). For example, a chat session may be generated automatically based on detection that a chat application 112 of a given entity 110 has been invoked (e.g., for automatic generation of one or more chat sessions between the chat application 112 of the given entity 110 and one or more chat applications 112 of one or more entities 110 on a contact list of the given entity 110), based on detection that an entity 110 has been added to a contact list 113 of a chat application 112 of a given entity 110 (e.g., addition based on a location of the given entity 110, based on context information associated with the given entity 110, based on association of a human entity 110 with a process, or the like, as well as various combinations thereof), based on detection that a sensor value of a sensor satisfies a threshold (e.g., based on a determination that a blood pressure monitor that is monitoring the blood pressure of a person indicates that the blood pressure has risen above threshold), based on detection that a person or object enters a particular location (e.g., when signals between a cell phone and a device associated with chat system 100 indicate that a person carrying the cell phone has entered a particular location (e.g., a geographic location, a store, an aisle within a store, a hotel, a library, or the like)), based on detection of a signal or message from a program or device (e.g., a signal from a timer indicating that a time period has expired or a time has been reached, a meeting alert message from a calendar program running on a smartphone of a user, or the like), based on device or program state, based on receipt of a message, or the like, as well as various combinations thereof. For example, detection that a chat application 112 of a given entity 110 has been invoked may result in automatic generation of chat sessions between the chat application 112 of the given entity 110 and various contacts on a contact list 113 of the chat application 112 of the given entity 110. For example, detection that an entity 110 has been added to a contact list 113 of a chat application 112 of a given entity 110 may result in automatic generation of a chat session between a chat application 112 of the given entity 110 and various contacts on a contact list 113 of the chat application 112. For example, detection that a blood pressure of a user exceeds a threshold may result in automatic generation of a chat session between the user and a doctor. For example, detection that a user has entered a particular area of a city may result in automatic generation of a chat session between the user and a city section buddy associated with that section of the city (e.g., a software buddy which may use the chat session to alert the user to stores, restaurants, tourist attractions, or other locations of potential interest to the user). For example, detection that a user has entered a store may result in automatic generation of a chat session between the user and a store buddy associated with the store (e.g., a software buddy which may use the chat session to alert the user to sale items and other store-related information). For example, detection that a user has entered a library may result in automatic generation of a chat session between the user and a library buddy (e.g., a software buddy which may use the chat session to alert the user to new books available in the library). For example, detection of a signal indicating that a timer has expired may result in automatic generation of a chat session between a smartphone of a user and a buddy associated with the timer. For example, detection of a meeting alert message from a calendar program running on a smartphone of a user may result in automatic generation of a chat session between the smartphone of the user and a buddy associated with the calendar program (e.g., a software buddy which may use the chat session to send a meeting agenda and associated meeting documents to the smartphone via the chat session for use by the user during the associated meeting). It will be appreciated that the foregoing examples represent merely a few of the conditions under which chat sessions may be automatically generated (and used after being generated).

The automatic generation of a chat session may include initiation of a chat session between two or more chat buddies already known to each other (e.g., each chat buddy is already included in the respective contact list(s) of the other chat buddy or buddies to be part of the chat session), initiation of a chat session between two or more chat buddies not already known to each other (e.g., which may include a preliminary step of automatically adding each chat buddy to the contact list(s) of the other chat buddy or buddies to be part of the chat session), or the like, as well as various combinations thereof (e.g., initiation of a chat session between two or more buddies already known to each other and then adding one or more additional buddies to the session). The automatic initiation of the chat session may be controlled by various elements of chat-based system 100 (e.g., chat-based core 130 may signal one or more entity representatives 120 to initiate the chat session, chat-based core 130 may signal one or more entities 110 to initiate establishment of the chat session, the chat application(s) 112 of one or more entities 110 may control initiation of the chat session, or the like, as well as various combinations thereof). It will be appreciated that the element(s) involved in initiation of the chat session may depend on various factors (e.g., which element(s) detects a condition that triggers automatic generation of a chat session, configured distribution of functions across elements of chat-based system 100, or the like, as well as various combinations thereof).

The automatic generation of chat sessions may be supported by configuring the chat-based system 100 to support automatic generation of chat sessions. The chat-based system 100 may be configured to monitor for conditions associated with generation of chat sessions and to generate chat sessions based on detection of conditions associated with generation of chat sessions. The monitoring may be performed within the context of existing chat sessions or outside of the context of existing chat sessions (e.g., based on message types of messages exchanged within existing chat sessions, based on content of messages exchanged within existing chat sessions, or the like, as well as various combinations thereof). The monitoring may be performed based on information from devices which are not participating in chat sessions or which are not configured to participate in chat sessions (e.g., servers supporting location-based services, devices supporting management of sensors or transmission of values or information measured by sensors (e.g., temperature sensors, motion sensors, blood pressure monitors, or the like), or the like, as well as various combinations thereof). For example, chat-based system 100 may support interfaces to servers providing location-based services for mobile device users and may use the interfaces to monitor for location-based conditions associated with generation of chat sessions (e.g., initiating generation of a chat session between a chat application running on a mobile device of a user and a store software buddy of a store based on detection that the mobile device of the user is near the store, initiating generation of a chat session between a chat application running on a first mobile device of a first user and a chat application running on a second mobile device of a second user based on detection that the first mobile device and the second mobile device are located within a threshold distance from each other, or the like). For example, chat-based system 100 may support interfaces to devices supporting management of sensors or transmission of values or information measured by sensors and may use the interfaces to monitor for sensor-based conditions associated with generation of chat sessions (e.g., initiating generation of a chat session between a chat application running on a mobile device of a user and a home environment control software buddy available to the user based on a determination that a motion sensor in the home of the user detects motion within the home, initiating generation of a chat session between a chat application running on a mobile device of a user and a chat application on a user device of a doctor based on a determination that a blood pressure value reported by a blood pressure sensor of the user is outside an expected range, or the like). The chat-based system 100 may support interfaces to various other devices for monitoring for conditions which trigger automatic generation of chat sessions.

It will be appreciated that, although primarily described with respect to embodiments in which chat-based system 100 performs monitoring based on processing of information obtained through interfaces with other elements (e.g., networks, devices, or the like), chat-based system 100 may be configured to perform monitoring based on information where the information may be obtained by chat-based system 100 in any other suitable manner. For example, other elements may be configured to report information or information satisfying pre-defined criteria, information may be retrieved from other elements via queries or other suitable types of requests, or the like, as well as various combinations thereof.

It will be appreciated that, although primarily described with respect to embodiments in which chat-based system 100 performs monitoring based on processing of information obtained through interfaces with other elements (e.g., networks, devices, or the like), chat-based system 100 may be configured to support various monitoring functions locally. For example, for monitoring of a set of sensors, chat-based system 100 may maintain a database (or other suitable collection of information) that includes records for each of the sensors (e.g., where each sensor record includes sensor description information, identity and contact information of an associated entity 110 with which the sensor is associated, the value(s) of interest that are the basis for detection of conditions, identity and contact information of an associated entity 110 to be contacted when the value(s) of interest are detected, or the like, as well as various combinations thereof) and initiate establishment of a chat session between the entity 110 with which the sensor is associated and the entity 110 to be contacted based on detection that the sensor is reporting a value(s) corresponding to the value(s) of interest. For example, for monitoring locations of a set of entities 110 associated with chat-based system 100, chat-based system 100 may maintain a database (or other suitable collection of information) that includes location condition record for each entity 110 in the set of entities 110 (e.g., where each location condition record includes identity and contact information of the given entity 110 with which the location condition record is associated), the device or devices for which location tracking is to be performed (which may be the same as or different than the device on which the associated chat application 112 of the given entity 110 is executed), the location(s) of interest that are the basis for detection of conditions, identity and contact information of an associated entity 110 to be contacted when the location(s) of interest are detected, or the like, as well as various combinations thereof) and initiate establishment of a chat session between the given entity 110 with which the location record is associated and the entity 110 to be contacted based on detection that a device or devices for which location tracking is to be performed is located in the location(s) of interest.

The automatic generation of chat sessions may be supported by providing entities 110 with a capability to configure the chat-based system 100 to support automatic generation of chat sessions. For example, a user may configure a chat application 112 such that chat sessions are automatically generated between the chat application 112 and one or more contacts on a contact list 113 of the chat application 112 responsive to invocation of the chat application 112. For example, a doctor using a chat application 112 may configure chat-based system 100 (e.g., via control over monitoring functions executing on chat-based core 130) to monitor the blood pressures of a number of patients (e.g., adding/removing patients to/from a patient monitoring list as needed) and, for each monitored patient whose blood pressure moves outside of a safe range specified by the doctor for that patient, to initiate a chat session between the chat application 112 of the doctor and an associated chat application 112 of the patient. For example, a technician or developer responsible for managing a chat application 112 operating as a city section buddy for a section of a city may configure chat-based system 100 (e.g., via control over functions executing on chat-based core 130) to control conditions under which chat sessions are automatically generated (or information provided via automatically generated chat sessions, such as available tourist attractions, coupons for stores, or the like) for users that enter that particular section of the city. For example, a technician or developer responsible for managing a chat application 112 operating as a store buddy for a store may configure chat-based system 100 (e.g., via control over functions executing on chat-based core 130) to control conditions under which chat sessions are automatically generated (or information provided via automatically generated chat sessions, such as alerts for sale items, coupons, or the like) for users that enter that store. For example, a technician or developer responsible for managing a chat application 112 operating as a library buddy for a library may configure chat-based system 100 (e.g., via control over functions executing on chat-based core 130) to control conditions under which chat sessions are automatically generated (or information provided via automatically generated chat sessions, such as alerts for newly available books) for users that enter the library. For example, a person using a chat application 112 may configure chat-based system 100 (e.g., via control over functions executing locally on a device on which the chat application 112 is running) to initiate a chat session between the chat application 112 of the person and an associated chat application 112 of an entity 110 based on detection that a timer has expired. For example, a person using a chat application 112 may configure chat-based system 100 (e.g., via control over functions executing locally on a device on which the chat application 112 is running) to initiate a chat session between the chat application 112 of the person and an associated calendar program buddy (associated with a calendar program running on the device on which the chat application 112 is running) based on detection of a meeting alert message from the calendar program. It will be appreciated that the foregoing examples represent merely a few of the conditions under which chat sessions may be automatically generated (and used after being generated).

The automatic generation of chat sessions provides various advantages. The automatic generation of chat sessions may make use of the chat-based system 100 more convenient for the users. The automatic generation of chat sessions may make interaction between various entities human and/or non-human) more convenient. The automatic generation of chat sessions may enable larger communities of interest to be served by chat-based system 100. In at least some embodiments, a software buddy (e.g., representing a device, program, or the like) may be inserted into an automatically generated chat session, thereby making interaction between people and devices more convenient. The automatic generation of chat sessions may provide various other advantages.

Referring again to FIG. 1 it is noted that, as described hereinabove, in at least some embodiments, chat-based system 100 may be configured to support extended operations functions (e.g., extended operations functions 401₄ depicted and described with respect to FIG. 4). The extended operations functions may include various functions beyond functions typically associated with chat-based systems (namely, interactive, serial message exchange among people). The extended operations functions also may be referred to herein as embedded operations functions.

The extended operations functions may include functions associated with a chat session, functions associated with a group of chat sessions, functions independent of any particular chat session(s), or the like, as well as various combinations thereof.

The extended operations functions may include functions associated with a chat session that are executed before the chat session is established, during the existence of the chat session, after the chat sessions has been terminated, or various combinations thereof. It will be appreciated that implementation of such functions associated with different times in the lifecycle of the chat session may be common, overlapping, or distinct.

The extended operations functions may include functions associated with a chat session that are executed before the chat session is established.

For example, chat-based system 100 may be configured to support scheduling functions for controlling scheduling of chat sessions. For example, chat-based system 100 may be configured to manage scheduled chat sessions having chat session scheduling information associated therewith (e.g., schedule chat time, scheduled chat participants, content to be used during the chat session, or the like), using the chat session scheduling information to send messages to scheduled chat participants to notify them of upcoming chat sessions.

The extended operations functions may include functions which may be executed during a chat session, which may include functions executed within the context of the chat session or outside of the context of the chat session. The extended operations may include functions which may be performed based on message types of messages exchanged within the chat session, content exchanged with the chat session, or the like, as well as various combinations thereof.

In at least some embodiments, chat-based system 100 may be configured to support various functions related to changes to the set of chat participants of the chat session, including addition of new chat participants to the chat session, removal of existing chat participants from the chat session. The addition of new chat participants may be performed automatically (e.g., based on detection of association of a new chat participant with one or more of the existing chat participants, based on context information associated with the new chat participant and one or more existing chat participants, or the like). Similarly, the removal of existing chat participants may be performed automatically (e.g., based on detection of loss of association between the leaving chat participant and one or more of the existing chat participants, based on context information associated with the leaving chat participant and one or more existing chat participants, or the like). The addition of a new chat participant may include providing the new chat participant with context information of the existing chat session (which may include context information for the group of existing chat participants of the chat session). The removal of an existing chat participant may include providing the remaining chat participants with updated context information related to removal of the existing chat participant from the chat session.

In at least some embodiments, chat-based system 100 may be configured to support message modification functions for messages exchanged during a chat session. The message modification functions may support processing of information of the message to convert the information of the message into modified information. The message modification functions may include receiving information provided by a first entity 110 and intended for delivery to a second entity 110, processing the information to convert the information into modified information (e.g., translating the information from one format to another such as for translating messages between a first format supported by the first entity 110 and a second format supported by the second entity 110, supplementing the information with additional information, or the like, as well as various combinations thereof), and propagating the modified information toward the second entity 110. For example, chat-based system 100 may be configured, within the context of a chat session between a first entity 110 supporting a first message format (e.g., human readable text where the first entity 110 is a human entity) and a second entity 110 supporting a second message format (e.g., machine readable text where the second entity 110 is a non-human entity), to translate messages of the chat session between the first format supported by the first entity 110 and the second format supported by a second entity 110.

In at least some embodiments, chat-based system 100 may be configured to monitor information exchanged within a chat session (e.g., messages, embedded content, or the like, which may be monitored based on keywords or other suitable monitoring mechanisms) and to initiate various actions based on detection of various conditions (e.g., modifying a message including offensive or sensitive information by removing the offensive or sensitive information from the message to form an edited message and then delivering the edited message to the other chat participant(s), filtering offensive or sensitive messages to block undesirable or inappropriate distribution of the offensive or sensitive messages, initiating establishment of a new chat session(s) based on detection of a message or messages indicative that a new chat session(s) is necessary or desirable, performing a question management function responsive to a determination that a message includes a question, performing an answer management function responsive to a determination that a message includes an answer to a question, changing a message attribution of a message based on an indication that the message attribution of the message is to be changed (e.g., changing the attribution from a user posting the message to an anonymous user identifier, changing the attribution from a user posting the message to a group of users including the user posting the message and at least one additional user, or the like), initiating one or more additional actions based on message type or content, or the like, as well as various combinations thereof).

In at least some embodiments, chat-based system 100 may be configured to support enhanced capabilities based on message types of messages exchanged within chat sessions. The message types of messages exchanged within chat sessions may be explicitly indicated in the messages, determined based on content included within the messages, or the like, as well as various combinations thereof. The message types may include “action” messages, “question” messages, “answer” messages, or the like, as well as various combinations thereof. For example, “action” messages may be processed to identify and initiate actions specifically requested by the chat participants from which the “action” messages are received, respectively. For example, “question” messages may be distributed to chat participants of the chat session (e.g., for enabling the chat participants to vote on questions, provide answers to questions, vote on answers to questions, or the like, as well as various combinations thereof), collected from chat participants of the chat session (e.g., to be answered by one or more facilitators or moderators of the chat session), or the like, as well as various combinations thereof. For example, “answer” messages may be distributed to chat participants of the chat session (e.g., from other chat participants of the chat session, from one or more facilitators or moderators of the chat session, or the like), processed to collect information related to priority of questions distributed or collected via the chat session, processed to collect voting results related to selection of answers posed as part of a question distributed or collected via the chat session, or the like), or the like, as well as various combinations thereof. It will be appreciated that, although primarily described with respect to support of enhanced capabilities for specific message types of messages exchanged within chat sessions (e.g., “action messages, “question” messages, and “answer” messages), chat-based system 100 may be configured to support enhanced capabilities based on various other message types of messages exchanged within chat sessions.

In at least some embodiments, the chat-based system 100 may be configured to detect the availability of executable software associated with a communication channel of a chat session and initiate execution of the executable software. The executable software may be said to be associated with a communication channel of a chat session in that the executable software may be propagated within a message(s) that is propagated via the communication channel, stored on a node along the communication path, or the like. For example, presence of executable software within a chat message of a chat session may be detected by a node along the communication path of the chat session, and the node may retrieve the executable software from the message and execute the executable software. For example, executable software may be stored on a node along the communication path of the chat session and the node may execute the executable software based on a determination that the executable software should be executed (e.g., detection within a chat message of an indicator that the executable software is to be executed). For example, a message of a chat session could include a document with fields needing input (e.g., a form to be filled out) and special software could be executed in order to help a recipient of the message to fill out the document. For example, a “circulating” message may be supported among participants of a chat session such that the messages move from each reader to a subsequent participant until the original sender receives a notification that each of the other participants has received the original message (e.g., in a chat session including Alice, Bob, and Charlie, a chat message including a message-routing software module is sent from Alice to Bob, Bob receives the chat message and sends an answer (acknowledgment) to Alice and the message-routing software module is executed resulting in generation of a chat message to Charlie, Charlie receives the chat message and sends an answer (acknowledgment) to Alice and the message-routing software module is executed resulting in generation of a chat message to Alice, and so forth).

In at least some embodiments, the chat-based system 100 may be configured to store content exchanged within the chat session (e.g., periodically, based on a trigger condition (e.g., detection of a specific type of content to be stored, detection of a request for specific content to be stored, or the like), or the like), store context information associated with the chat session (e.g., periodically, based on a trigger condition (e.g., detection of a change in context, detection of a request for context to be stored, or the like), or the like), or the like, as well as various combinations thereof.

The extended operations may include functions associated with a chat session that are executed after the chat session has terminated. For example, chat-based system 100 may be configured to maintain content generated during a chat session (e.g., using a content repository that can be queries by participants of the chat session after the chat session has been terminated). For example, chat-based system 100 may be configured to support scheduling functions for controlling scheduling of chat sessions (e.g., spawning establishment of one or more new chat sessions based on information exchanged within the context of the terminated chat session).

The extended operations may include various other types of functions. For example, chat-based system 100 may be configured to support context generation functions (e.g., generating various contexts for various chat sessions and using the context information to control execution of chat-based system 100), data analytics functions, relationship notification functions, or the like, as well as various combinations thereof.

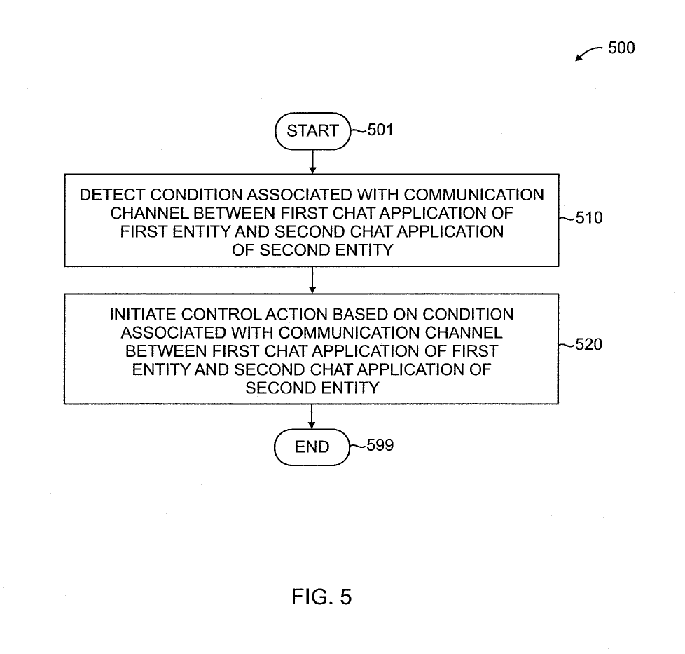

FIG. 5 depicts an exemplary embodiment of a method for supporting extended operations functions within a chat-based system. It will be appreciated that, although depicted and described as being performed serially, at least a portion of the steps of method 500 may be performed contemporaneously or in a different order than as depicted and described with respect to FIG. 5. At step 501, method 500 begins. At step 510, a condition associated with a communication channel, between a first chat application of a first entity and a second chat application of a second entity, is detected. At step 520, a control action is initiated based on the condition associated with the communication channel between the first chat application of the first entity and the second chat application of the second entity. At step 599, method 500 ends.

The configuration of chat-based system 100 to support extended operations functions provides various advantages. The configuration of chat-based system 100 to support extended operations functions may, via implementation of operations beyond those typically associated with chat-based systems, enable chat-based system 100 to be more a extensive and supportive chat-based system. The configuration of chat-based system 100 to support extended operations functions may extend the convenience, usefulness, and scope of application of various chat-based communications supported by the chat-based system 100. The configuration of chat-based system 100 to support extended operations functions may enable support for various additional use cases (some examples of which have been described above). The configuration of chat-based system 100 to support extended operations functions may extend the scope and use of chat-based system 100 into other types of environments, activities, or the like, as well as various combinations thereof. The configuration of chat-based system 100 to support extended operations functions may enable software buddies to be used as a mechanism for integrating, coordinating, or otherwise interacting with the execution of other (so-called “outside” or “third-party”) software. The configuration of chat-based system 100 to support extended operations functions may significantly increase the use and value of the chat-based system 100. The configuration of chat-based system 100 to support extended operations may provide various other advantages.

Referring again to FIG. 1 it is noted that, as described hereinabove, in at least some embodiments, chat-based system 100 may be configured to support relationship identification and notification functions (e.g., relationship identification and notification functions 401₅ depicted and described with respect to FIG. 4). The chat-based system 100 may be configured to identify a relationship between two or more entities 110 and to notify the entities 110 of the existence of the relationship. The relationships may include one or more of pre-existing relationships, developing relationships, potential relationships, or the like, as well as various combinations thereof.

In general, people are often unaware of how they are related to people and objects around them. For example, a person might be sitting next to stranger in a train station, but those people might have both just posted comments online in response to a recent news report. Similarly, two people standing in line in a store or amusement park might have a common Facebook friend. For example, a person might be near a retail store that is selling an item the person has researched online. In each of these cases, as well as various other cases, relationship identification and notification functions supported by chat-based system 100 could be executed to make people more aware of their surroundings (e.g., of relationships with other people or objects), thereby enabling increased engagement by those people with interesting people or objects.

The chat-based system 100 may be configured to perform relationship identification functions. The chat-based system may be configured to identify a relationship between two or more entities 110. The identification of a relationship between entities 110 may be performed based on processing of information exchanged within chat-based system 100 (e.g., via chat-based sessions between entities 110, between entities 110 and associated entity representatives 120, between entity representatives 120, between chat-based core 130 and entity representatives 120, or the like, as well as various combinations thereof). The identification of a relationship between entities 110 may be performed based on processing of information available from one or more sources of information external to chat-based system 100 (e.g., location-based services servers of a communications service provider, servers of a social media provider, or the like, as well as various combinations thereof). The information available from one or more external sources of information external to chat-based system 100 may be obtained by chat-based system 100 in any suitable manner (e.g., via dedicated interfaces established between chat-based core 130 and external sources of information, via automated reporting of information by external sources of information to chat-based core 130, via querying of external sources of information by chat-based core 130, or the like, as well as various combinations thereof). The identification of a relationship between entities 110 may be performed for entities 110 determined to be within relevant proximity of each other (which may vary across entities 110, relationship types, or the like). For example, chat-based system 100 may be configured to use location information from location-based services servers to determine relationships based on location. For example, chat-based system 100 may be configured to use connection information, indicative of connections between people on social media websites, from servers of the social media websites to determine relationships based on indications of common connections (which may include degrees of connection). For example, chat-based system 100 may be configured to use object location and capability information, from object management servers, to determine relationships based on object location and capability information (e.g., a location and capabilities of a printer for determining whether a user is located near the printer and is using a device capable of interfacing with the printer for sending documents to the printer for printing, a location and capabilities of a home entertainment system control module for determining whether the user is located at home and indicating to the user the types of actions the user may take to control the home entertainment system, or the like). It is noted that various other types of information, available from various sources of such information, may be used by chat-based system 100 to identify relationships between entities.

The chat-based system 100 may be configured to perform relationship notification functions. The chat-based system 100 may be configured to notify one or more entities 110 of identification of a relationship between the entities 110 (e.g., a subset of the entities 110 of the identified relationship, all of the entities 110 of the identified relationship, or the like). The chat-based system 100 may be configured to notify an entity 110 of identification of a relationship for the entity 110 via a chat message propagated via the chat application 112 of the entity 110 (e.g., via a chat message sent in a communication channel 140 dedicated for use in reporting identified relationships to the entity 110, via a chat message sent in an existing communication channel 140 supported by the entity 110, or the like, as well as various combinations thereof), via a message propagated outside of the chat application 112 of the entity 110 (e.g., via a text message or other suitable messaging framework), or the like, as well as various combinations thereof. The notification sent to an entity 110 identifies one or more other entities 110 of the identified relationship and, optionally, may include information which may be used by the entity 110 to find or contact the one or more other entities 110 (e.g., the physical location(s) of the one or more other entities 110, contact information for the one or more other entities 110, or the like, as well as various combinations thereof). The notification sent to an entity 110 may be in a form adapted to enable the entity 110 to provide feedback regarding the identified relationship (e.g., to indicate whether or not the entity 110 believes the identified relationship is valid or useful, to indicate whether or not the entity 110 intends to pursue or act upon the identified relationship, to indicate whether or not the entity 110 would like to be notified of similar relationships identified for the entity 110 in the future, or the like, as well as various combinations thereof). The notification sent to an entity 110 may be in the form of an introduction of the entity 110 to the one or more other entities 110 of the identified relationship. The notification sent to an entity 110 may be provided on user request or on program initiation. The notification sent to an entity 110 based on program initiation may be provided based on one or more metrics (e.g., when a new relationship that meets specified conditions is discovered and so forth). It will be appreciated that, where the entity 110 receives notifications of identified relationships within the context of the chat application 112 of the entity 110, such additional information, feedback options, or the like may be provided within the context of the chat application 112 of the entity 110, further facilitating management and use of identified relationships by the entity 110. It will be appreciated that various other types of information or capabilities may be provided to the entity 110 in conjunction with notification of the entity 110 regarding identification of relationships for the entity 110.

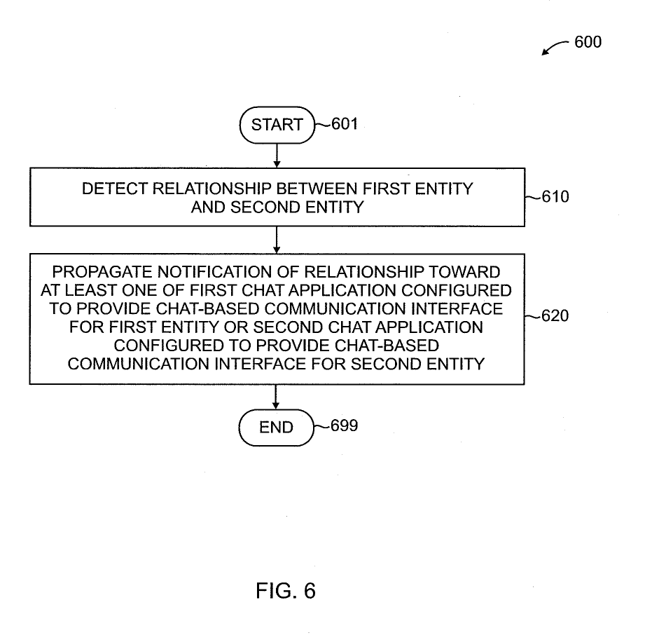

FIG. 6 depicts an exemplary embodiment of a method for supporting relationship identification and notification within a chat-based system. It will be appreciated that, although depicted and described as being performed serially, at least a portion of the steps of method 600 may be performed contemporaneously or in a different order than as depicted and described with respect to FIG. 6. At step 601, method 600 begins. At step 610, a relationship between a first entity and a second entity is detected. At step 620, a notification of the relationship is propagated toward at least one of a first chat application configured to provide a chat-based communication interface for the first entity or a second chat application configured to provide a chat-based communication interface for the second entity. At step 699, method 600 ends.

It will be appreciated that, although primarily described with respect to embodiments in which relationship identification and notification is performed within the context of a chat-based system (e.g., chat-based system 100 or any other suitable chat-based system), in at least some embodiments relationship identification and notification may be performed within other types of systems or environments.

In at least some embodiments, for example, relationship identification and notification may be performed by a server or other device which may be operating within a communication environment. The server or other device may be configured to access information for use in identifying relationships between entities, process the information to identify relationships between entities, and propagate notifications of identified relationships between entities. The entities may register for and use the relationship identification and notification service via an application which may be downloaded by the entity (e.g., onto a device associated with the entity (e.g., for a human entity, an object, or the like), onto the entity where the entity itself supports communication capabilities, or the like). For example, an entity may use the application to configure the types of information which may be used to identify relationships for the entity, the manner in which identified relationships are communicated to the entity, the manner in which the entity is alerted to identified relationships communicated to the entity (e.g., display of an alert message, vibration of the user device, or the like), the manner in which the entity may further pursue the relationship (e.g., accept or decline the identified relationship as being a valid or invalid relationship, initiation of an introduction message or call, or the like), or the like, as well as various combinations thereof. For example, an entity may receive notification of identified relationships via the application. For example, an entity, after receiving a notification of an identified relationship, may access additional information about the identified relationship via the application. For example, an entity, after receiving a notification of an identified relationship, may accept or decline the identified relationship via the application. For example, an entity, after receiving a notification of an identified relationship, may initiate a connection with one or more other entities of the identified relationship via the application. It will be appreciated that various other functions supported by chat-based systems for relationship identification and notification also may be supported via the application.

In at least some embodiments, for example, relationship identification and notification may be performed using a software framework (e.g., including control software and associated input and output functions) that manages a set of data analytical functions to discover and report relationships (e.g., pre-existing relationships, developing relationships, or the like, as well as various combinations thereof) between a service user and nearby people and objects. In at least some embodiments, a program executing on a service customer endpoint device provides notifications of relationships between that person and nearby people or objects. The notifications can be provided, on user request or on program initiation, according to service parameter settings used by the program executing on the service customer endpoint. It will be appreciated that program-initiated notifications can be provided according to various metrics (e.g., when a new relationship that meets specified conditions is discovered and so forth). The relationships may be discovered by data analytical software functions executing on a remote server or servers. The endpoint program and analytical software may communicate via messages transmitted between the endpoint device and server. The analytical software may identify relationships based on data that is retrieved through queries to one or multiple databases. The analytical software may identify relationships based on data that is gathered through streams of data (e.g., geo-location updates for mobile devices streamed from cell node controllers, M2M communications between devices, or the like). The analytical software may be configured to discover relationships among proximate people or objects based on such information and to report discovered relationships to the service control software executing on the user endpoint.

The use of relationship identification and notification functions, whether used within the context of a chat-based system or independent of a chat-based system, provides various advantages. The use of relationship identification and notification functions may enable identification and notification of relationships without requiring user devices to broadcast user interest lists and without requiring user devices to receive and process broadcasted user interest lists, thereby improving identification and notification of relationships while reducing overhead (e.g., communication overhead, processing overhead, or the like), improving and expanding the scope of relationships which may be identified and notified (e.g., relationships that would or could not have been identified through comparison of user interest lists, relationships between people and objects, relationships between objects, or the like, as well as various combinations thereof). The use of relationship identification and notification functions, by facilitating identification and notification of relationships within the context of an autonomous framework, significantly improves and expands the scope of relationships which may be identified and notified (e.g., identification and notification of relationships in a mobile environment, identification and notification of relationships in a changing environment, or the like, as well as various combinations thereof). The use of relationship identification and notification functions is expected to create new communication opportunities (e.g., new communication opportunities among people, new communication opportunities among people and objects, new communication opportunities among objects, or the like). The use of relationship identification and notification functions may provide various other advantages.

Referring again to FIG. 1 it is noted that, as described hereinabove, in at least some embodiments, chat-based system 100 may be configured to support management of questions and answers exchanged within the context of chat-based system 100 (e.g., question/answer management functions 401₆ depicted and described with respect to FIG. 4).

In at least some embodiments, chat-based system 100 may be configured to monitor for questions or answers within a chat session and to perform various control actions based on detection of questions within the chat session (e.g., propagation of questions to particular chat participants of the chat session, distribution of questions to all chat participants of the chat session, generation of a questionnaire or other structured collection of questions (e.g., survey, ballot, or the like), or the like, as well as various combinations thereof) or perform various control actions based detection of answers within the chat session (e.g., propagation of answers to particular chat participants of the chat session, distribution of answers to all chat participants of the chat session, generation of voting results or other structured collections of answers, or the like, as well as various combinations thereof). The detection of questions and answers within a chat session may be performed by monitoring message types of the messages exchanged within the chat session, monitoring content of messages exchanged within the chat session, or the like, as well as various combinations thereof. For example, questions or answers may be indicated within chat messages using particular strings of text, symbols, or other appropriate information, or various combinations thereof (e.g., “question” for messages includes questions, “answer” for messages including answers, “#question” for messages includes questions, “#answer” for messages including answers, or the like).

In at least some embodiments, chat-based system 100 may be configured to detect a question from a chat participant of a chat session and to use the chat session to distribute the question to the other chat participants of the chat session. For example, the question may be submitted in a chat message by any participant of the chat session, by a moderator or facilitator of the chat session (e.g., a teacher within the context of a chat session supporting a learning environment, a corporate executive within the context of a chat session supporting a virtual corporate town hall meeting, or the like), or the like. The question may be distributed to the other chat participants in the form of chat messages (including the question) provided to the other chat participants within the chat session, presentation of answer buttons (e.g., “yes” and “no” answer buttons or other appropriate answer buttons) to the other chat participants of the chat session, or the like, as well as various combinations thereof. The question may be distributed to the other chat participants of the chat session for enabling the other chat participants to submit answers to the question, for enabling the other chat participants to vote on answers provided in conjunction with the question, or the like, as well as various combinations thereof.

In at least some embodiments, chat-based system 100 may be configured to collect questions from one or more chat participants of a chat session. The collected questions may be distributed to all chat participants of the chat sessions, distributed to respective sets of chat participants of the chat session (e.g., based on roles of the chat participants and the content of the questions, respectively), provided to one or more facilitators of the chat session (e.g., a teacher within the context of a chat session supporting a learning environment where students may submit questions for consideration by the teacher, a corporate executive within the context of a chat session supporting a virtual corporate town hall meeting where employees or other people participating in the virtual corporate town hall meeting may submit questions for consideration by the corporate executive, or the like), or the like, as well as various combinations thereof. The questions may be distributed to a chat participant or participants of the chat session in the form of chat messages (including the questions) provided to chat participants within the chat session, presentation of answer buttons (e.g., “yes” and “no” answer buttons or other appropriate answer buttons) to chat participants of the chat session, or the like, as well as various combinations thereof. The questions may be distributed to a chat participant or participants of the chat session for enabling chat participants to submit answers to the questions, for enabling chat participants to vote on the questions for which they would like to see answers (e.g., to prioritize the questions for handling by one or more facilitators of the chat session that are expected to answer at least some of the collected questions), for enabling chat participants to vote on answers provided in conjunction with the question, or the like, as well as various combinations thereof. The collected questions may be combined to form a questionnaire which may then be distributed using the chat session (e.g., to all chat participants of the chat sessions, a subset of the chat participants of the chat session, one or more facilitators of the chat session, or the like, as well as various combinations thereof.

In at least some embodiments, chat-based system 100 may be configured to detect one or more answer messages related to a question message and to process the one or more answer messages to provide one or more functions related to the question message (e.g., distribution of answers to questions, prioritization of questions, collection of voting results related to questions, or the like, as well as various combinations thereof). For example, a message from a chat participant of a chat session that includes an answer to a question received by the chat participant via the chat session may be distributed to each of the other chat participants of the chat session (e.g., for a question submitted by one of the chat participants, for a question submitted by a particular chat participant of the chat session such as a moderator or facilitator of the chat session, or the like), propagated to a particular chat participant of the chat session such as a moderator or facilitator of the chat session, or the like, as well as various combinations thereof. For example, a message from a chat participant of a chat session that includes reference to a question received by the chat participant via the chat session (e.g., including a hashtag and a reference identifying the question) may be counted for purposes of determining prioritization of questions posed by one or more chat participants during the chat session (e.g., for use in determining a priority order in which questions posed within the context of the chat session are to be addressed, such as by a facilitator or moderator of the chat session). For example, a message from a chat participant of a chat session that includes an answer to a question received by the chat participant via the chat session (e.g., including a set of answers and requesting that participants of the chat session vote on the question by selecting one of the answers) may be counted for purposes of determining voting results related to the question.

In at least some embodiments, chat-based system 100 may be configured to determine voting results based on processing of answer messages provided via a chat session and to distribute the voting results via the chat session. In at least some embodiments, where chat participants submit answer messages indicating interest in particular question messages, the questions of the question messages may be prioritized for priority based handling (e.g., the question referenced in the largest number of answer messages is addressed first, the question referenced in the next largest number of answer messages is addressed second, and so forth) and the results of question prioritization may then be propagated via the chat session (e.g., to all chat participants, to a subset of chat participants, to a facilitator or moderator of the chat session so as to inform the facilitator or moderator of the chat session of the order in which the questions must or should be handled, or the like, as well as various combinations thereof). For example, a teacher giving a presentation to students using a set of slides may distribute the slides via a chat session (joined by the teacher and the students), send a question to the students, and then be presented with answers submitted by the students via the chat session. For example, where a teacher is giving a presentation to students using a set of slides, the teacher may distribute the slides via a chat session (joined by the teacher and the students), the students may submit questions about the slides for consideration by the teacher (e.g., a student with a question about slide 17 which illustrates a graph may send a chat message including “what is the unit of measure on the x-axis in slide 4?”), students may vote on questions submitted by their fellow students (e.g., by sending a chat message including “#questionslide4”), and the teacher may then be presented with a prioritized list of the submitted questions for use in responding to the questions in a prioritized way. In at least some embodiments, where chat participants submit answer messages indicating selections of answers posed in conjunction with a particular question, votes by the chat participants for the answers posed in conjunction with the particular question may be collected and the voting results for the particular question may then be propagated via the chat session (e.g., to all chat participants, to a facilitator or moderator of the chat session in order to enable the facilitator or moderator of the chat session to report the results to the other chat participants, or the like, as well as various combinations thereof). For example, where a corporate executive is holding a virtual town hall meeting with employees via a chat session, the corporate executive may submit a question and two potential answers to the employees via the chat session (e.g., a question such as “Should we hold our next executive retreat in New York, Los Angeles, or Antwerp?”), the employees may vote on the question by sending messages including selected answers to the question, and the voting results may then be distributed to all of the chat participants (the corporate executive and the employees) via the chat session.

In at least some embodiments, chat-based system 100 may be configured to perform additional control actions based on questions or answers exchanged within a chat session. For example, an additional control action may include automatically displaying content to participants of the chat session. The automatic display of content to participants of the chat session may be performed based on detection that the content is referenced in a question or answer, based on detection that the content is referenced in a threshold number of questions or a threshold number of answers, or the like. The automatic display of content to participants of the chat session may be performed within the context of the chat session, outside of the context of the chat session, or a combination thereof. For example, an additional control action may include generating and providing guidance to a moderator or facilitator of a chat session based real-time feedback provided by chat participants via the chat session (e.g., hashtags such as #slowdown, #speedup, #repeat, or the like could be available to chat participants to enable the chat participants to provide real-time guidance and feedback to lecturers via the chat session). For example, an additional control action may include generation of identities of messages (e.g., based on serial numbering, question source, question topic, or the like, as well as various combinations thereof) or categorizations of messages (e.g., based on question source, question topic, reported level of interest in question, or the like, as well as various combinations thereof) for questions or answers. For example, an additional control action may include reporting answers or voting results to elements outside of the context of the chat session. Various other control actions are contemplated. These and other control actions may be better understood by considering the following example related to use of a chat session to facilitate a lecture by a professor to students. The professor and students may exchange messages within the context of the chat session, where certain messages may be configured to indicate the presence of information of interest within the messages (e.g., via use of hashtags or other suitable symbols or indicators to indicate the presence of questions or answers within the messages). The messages exchanged within the context of the chat session may be monitored to identify designated message content. The designated messages, or portions thereof, may be sent for presentation on various displays (e.g., all chat participants, the students only, the professor only, or the like). For example, the question portion of messages including the hashtag #question that are generated by students during a class lecture might be forwarded to a module managing display of information on a monitor being used by the professor. The designated messages, or portions thereof, may be analyzed for identification or categorization, and the identification or categorization may be associated with the messages or managed in various ways. For example, messages designated by the hashtag #question may be collected and content portions of the messages may be analyzed in order to generate question identities or categorizations, messages designated by the hashtag #answer may be collected and content portions of the messages may be analyzed to generate answer identities or categorizations, or the like. For example, messages may be analyzed based on natural language processing (e.g., using keyword identification or other natural language processing capabilities) to identify or classify messages or content of messages by message sources of the messages. For example, content portions of messages may be analyzed based on natural language processing (e.g., using keyword identification or other natural language processing capabilities) to identify or classify messages or content of messages by topic. For example, question or answer identities may be formed by labeling each question or answer with a hashtag using serial numbering (e.g., #Q1 for the first question, #Q2 for the second question, #A1 for the first answer, #A2 for the second answer, and so forth), using question source identifiers (e.g., #Quser1 for a question from User1, #Quser4 for a question from User4, #Auser6 for an answer from User6, #Auser3 for an answer from User4, and so forth). For example, question or answer categorizations may be formed by labeling each question or answer with category codes. For example, messages could be labeled automatically or by chat participants according to events occurring during the chat session. For example, students could label messages with the numbers of slides using during the class lecture, such as where chat participants label messages using hashtags corresponding to the slide material that is the basis for their questions (e.g., questions related to slide 14 could be labeled with the hashtag #slide14, such as by a message of “#slide14 what are the units of the x-axis measurements?”). For example, additional processing may be supported on the basis of the labeling of messages (e.g., when the professor has acknowledged receipt of the question related to slide 14, a slide projection control message could be sent so that the projector displays slide 14 for viewing by the students while the professor answers the question). It will be appreciated that identification, categorization, or marking of messages may be hierarchical (e.g., further categorizing one or more categories of messages into subcategories and so forth). It will be appreciated that questions or answers may be identified, categorized, marked, or managed in various other ways. The identification, categorization, or marking of messages may be used to provide additional functions (e.g., prioritization of messages per category, tallying of answers or votes per category, or the like). For example, chat participants could express their valuation of questions or answers by sending messages with the hashtags of the questions or answers (e.g., #Q1, #Q2, #A1, #A4, and so forth), and a prioritized ranking of at least some of the top-ranked questions or answers may be propagated for display to chat participants (e.g., the students and the professor, only the students, only the professor, or the like). For example, a count of the number of messages within a category may be tallied and this count may be transmitted for display on participant devices. The results of additional functions performed based on categorization of messages may be propagated to various sets of chat participants (e.g., all chat participants, subsets of chat participants, individual chat participants, or the like).

In at least some embodiments, although primarily described with respect to embodiments in which question messages and answer messages are generated by chat participants, chat-based system 100 (e.g., chat-based core 130, entity representatives 120, or the like) may be configured to generate question messages and answer messages based on messages generated by the chat participants. For example, where a given chat participant sends a question message, chat-based core 130 may be configured to detect the question message and to generate corresponding question messages to the chat participants asking the chat participants to answer the question. By generating question messages for the other chat participants, rather than merely forwarding the question message received from the given chat participant, the question may be formatted in a way that makes answering the question more convenient and intuitive than if the question message received from the given chat participant was forwarded (e.g., enabling display of answer selection options to enable the chat participants to select from a set of available answers rather than having to type answers). Similarly, for example, where a given chat participant sends an answer message, chat-based core 130 may be configured to detect the answer message and to generate corresponding answer messages to the chat participants. By generating answer messages for the other chat participants, rather than merely forwarding the answer message received from the given chat participant, the answer may be formatted in a way that makes understanding the answer more convenient and intuitive than if the answer message received from the given chat participant was forwarded (e.g., enabling display of the answer is a standard format). The chat-based system 100 may be configured to support other types of automated message generation within the context of managing questions and answers.

In at least some embodiments, chat-based system 100 may be configured to support management of questions and answers exchanged within the context of chat-based system 100 using a set of modules including a collector module (or modules) and a message processing module (or modules). The collector module may be configured to monitor the messages exchanged by chat participants (where certain messages may be configured to indicate the presence of information of interest within the messages, such as using hashtags or other suitable symbols or indicators to indicate the presence of questions or answers within the messages) and to record information included within messages of interest exchanged by chat participants (e.g., again, questions, answers, or the like, as well as various combinations thereof). The message processing function may be configured to handle the collected designated messages according to specified processing instructions, which may be pre-determined (e.g., before execution of the chat session), generated during the chat session, or the like, as well as various combinations thereof. The generation of processing instructions can be performed as part of execution of functions within chat-based system 100, in response to signals received from elements outside of chat-based system 100, or the like, as well as various combinations thereof. Accordingly, it will be appreciated that the message processing module may carry out various (and possibly changing) actions.

It will be appreciated that the foregoing embodiments and examples related to questions and answers are merely a few of the various ways in which questions and answers may be managed and used within the context of chat-based system 100.

It will be appreciated that, although primarily described with respect to embodiments in which question and answer management is performed within the context of a chat-based system (e.g., chat-based system 100 or any other suitable chat-based system), in at least some embodiments question and answer management may be performed within other types of systems or environments.

In at least some embodiments, for example, question and answer management may be performed by a server or other device which may be operating within a communication environment. The server or other device may be configured identify questions and answers and to take appropriate actions based on various parameters (e.g., sources of questions or answers, intended destinations of questions or answers, indications of the purposes of questions or answers, or the like, as well as various combinations thereof). The question and answer management functions may be provided within the context of an application which may be downloaded by entities that are to be parties to use of the question and answer management functions. For example, entities may use the application to generate questionnaires, collect votes based on distributed questionnaires, or the like, as well as various combinations thereof. It will be appreciated that various other functions supported by chat-based systems for question and answer management also may be supported via the application.

In at least some embodiments, for example, question and answer management may be performed using a software framework (e.g., including control software and associated input and output functions) that manages a set of data analytical functions to detect questions, generate questionnaires from questions, detect answers, generate results from answers (e.g., most likely answer, voting results for voting scenarios, or the like), or the like, as well as various combinations thereof. In at least some embodiments, a program executing on a service customer endpoint device provides notifications of availability of questions, availability of answer-based results, or the like, as well as various combinations thereof. The notifications can be provided, on user request or on program initiation, according to service parameter settings used by the program executing on the service customer endpoint. It will be appreciated that program-initiated notifications can be provided according to various metrics (e.g., questions of interest, voting results of interest, or the like). The management of questions and answers may be performed by data analytical software functions executing on a remote server or servers. The endpoint program and analytical software may communicate via messages transmitted between the endpoint device and server. The analytical software may detect questions, generate questionnaires from questions, detect answers, generate results from answers (e.g., most likely answer, voting results for voting scenarios, or the like), or the like, as well as various combinations thereof.

It will be appreciated that question and answer management functions may be performed within various other types of systems or environments.

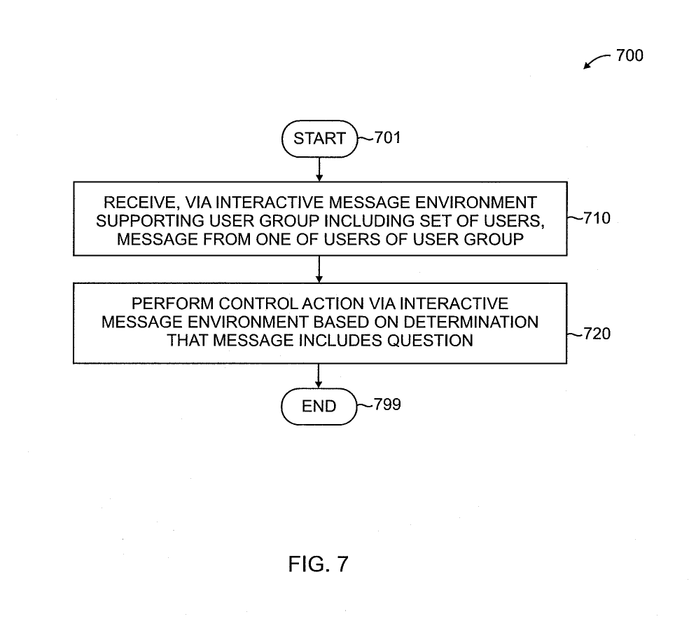

It will be appreciated that, although primarily described with respect to embodiments in which question and answer management is performed within the context of a particular type of interactive message environment (namely, a real-time group chat session of a chat-based system such as chat-based system 100 or any other suitable chat-based system supporting real-time group chat sessions), question and answer management may be performed within various other types of interactive message environments. For example, question and answer management may be performed within the context of other types of interactive message environments supporting real-time group chat sessions (e.g., a group chat or instant messenger capability via a social media site, an application that supports real-time messaging between users of user groups, or the like), within the context of interactive message environments supporting posting of messages by users (e.g., online message boards to which users may post and which other users may access in order to view and, optionally, respond to messages), or the like, as well as various combinations thereof. Accordingly, references herein to “interactive message environment” may be read more generally as being or including any system or platform supporting handling of messages which may include content related to management of questions or answers (e.g., questions, references to questions, answers, references to answers, or the like), where such messages may be automatically delivered to other users (e.g., via a chat session or other similar session supporting automated delivery of messages to users), posted for availability to other users (e.g., where the other users may or may not be notified regarding the availability of the posted messages), or the like, as well as various combinations thereof. Embodiments related to a more general implementation of message question and answer management are depicted and described with respect to FIG. 7.

FIG. 7 depicts an exemplary embodiment of a method for supporting question and answer management functions. It will be appreciated that, although depicted and described as being performed serially, at least a portion of the steps of method 700 may be performed contemporaneously or in a different order than as depicted and described with respect to FIG. 7. At step 701, method 700 begins. At step 710, a message is received via an interactive message environment. The interactive message environment supports a user group and the message is received from one of the users of the user group. At step 720, a control action is performed via the interactive message environment based on a determination that the message includes a question. At step 799, method 700 ends. It will be appreciated that, although primarily depicted and described with respect to embodiments in which a control action is initiated based on a determination that a message received via an interactive message environment includes a question, method 700 may be adapted to perform a control action based on a determination that a message received via an interactive message environment includes a reference to a question of a previous message, an answer to a question of a previous message, a reference to an answer of a previous message, or the like, as well as various combinations thereof.

The use of question and answer management functions, whether used within the context of a chat-based system or independent of a chat-based system, provides various advantages. The use of question and answer management functions may provide direct support for the intermediate messages and response tallies that are needed for distributing questions or answers, organizing opinions, counting votes, or the like, as well as various combinations thereof. The use of question and answer management functions, especially within the context of a chat-based system, may enable people to conveniently and intuitively request or provide opinions or votes during chat sessions. The use of question and answer management functions, especially within the context of a chat-based system, may provide convenient and intuitive interfaces for enabling users to generate and publish collections of questions (e.g., questionnaires, ballots, or other structured requests for information), distribute or publish collections of answers (e.g., answers to questions, votes, or other structured feedback), or the like, as well as various combinations thereof. The use of question and answer management functions may expand the popularity of electronic voting and feedback on ad-hoc issues. The use of question and answer management functions within conferencing systems may increase the value of conferencing systems, thereby tending to increase use of such systems. The use of question and answer management functions may provide other advantages.

It will be appreciated that, although primarily depicted and described with respect to embodiments in which questions and answers are generated by human entities involved in a chat session, as previous discussed herein the chat-based system 100 may be configured to support management of questions and answers where the questions or answers may be provided by non-human entities. In at least some embodiments, for example, a question may be a request to execute a remote procedure call to obtain some information and the information that is received responsive to the remote procedure may be considered to be the associated answer. For example, a user may participate in a group chat session with each of the cars of the household and may ask a question such as “how much gasoline did each of you consume last week?” within the context of the group chat session, detection of the question by the chat applications of the cars via the chat session causes each of the cars to perform a local query for gas usage in accordance with the question (e.g., a query from the chat application of the car to a gas consumption monitor function of the car), and each of the cars may then report its gas usage within the context of the group chat session. For example, a chat entity configured to collect information about household expenditures may be configured by a head of the household to participate in a group chat session with each of the members of the household and to periodically query the members of the household for information regarding specific types of expenditures made by the members of the household, the queries from the chat entity to the members of the household may be delivered and presented to the members of the household via their respective chat applications, the members of the household may respond to the queries by providing the expenditure information requested by the chat entity, and the chat entity may be process the received expenditure information (e.g., to generate reports for the head of the household, to trigger alerts to be provided to the head of the household, or the like). It will be appreciated that the foregoing examples are merely a few of the various ways in which questions/queries and answers/information may be exchanged within the context of a chat session.

It will be appreciated that, although primarily depicted and described with respect to embodiments in which any indicators (e.g., hashtags, specific characters or character strings, or other indicators) may be used to indicate specific types of content to be acted upon (e.g., questions, content related to questions, answers, content related to answers, or the like), in at least some embodiments the chat-based system 100 may be configured to support management of content exchanged within the context of chat-based system 100 based on identification of specific indicators within messages transporting the content. For example, any message including a hashtag or other suitable type of indicator may be detected and acted upon, where the control action that is triggered may be dependent on or independent of the content that is included within the detected message.

It will be appreciated that, although primarily depicted and described with respect to embodiments in which specific control actions related to management of questions and answers are supported (e.g., distribution of questions or answers to chat participants, display of questions or answers to display screens, generation of questionnaires, concatenation of answers such as for voting or other purposes, or the like), in at least some embodiments the chat-based system 100 may be configured to support various other types of control actions which may be performed responsive to detection of messages including certain types of indicators, content, or combinations thereof. For example, other types of control actions may include initiation of a call or message to a phone or computer, initiation of a local procedure call or a remote procedure call, or the like, as well as various combinations thereof.

Referring again to FIG. 1 it is noted that, as described hereinabove, in at least some embodiments, chat-based system 100 may be configured to support management of message attribution for messages exchanged within the context of chat-based system 100 (e.g., message attribution management functions 401₇ depicted and described with respect to FIG. 4).

In at least some embodiments, chat-based system 100 may be configured to provide various levels or degrees of privacy to chat participants in a chat session. The chat-based system 100 may be configured to provide privacy to a chat participant of a chat session by receiving a message of the chat participant that has a message attribution indicative that the message is attributed to the user, modifying the message attribution for the message to form a modified message attribution for the message, propagating the message for delivery to chat participants of the chat session using the modified message attribution for the message.

In at least some embodiments, chat-based system 100 may be configured to provide various levels or degrees of privacy to chat participants in a chat session by enabling chat participants to control the level of privacy applied to messages exchanged within the context of chat sessions. A chat participant may be given a capability to specify the manner in which the source of the chat participants messages are to be described (e.g., attributed to the chat participant, made anonymous, attributed to a group of chat participants which may or may not include the chat participant which is the source of the message, or the like). A chat participant may set his or her privacy settings for controlling message attribution for individual messages, for groups of messages (e.g., a number of messages, a time period, messages having specified properties (e.g., a specified word, a specified hashtag, or the like)), for individual chat sessions, for groups of chat sessions (e.g., chat sessions including specified chat participants, chat sessions including threshold numbers of chat participants, or the like), for all chat sessions (e.g., per message or for groups of messages across chat sessions), or the like, as well as various combinations thereof. A chat participant may set his or her privacy settings for controlling message attribution via selection of one or more options associated with creation of a chat message (e.g., where pre-defined settings (e.g., INDIVIDUAL, GROUP, ANONYMOUS, or the like) are available for selection in conjunction with message creation), via inclusion of information within a chat message (e.g., an indicator of the level or type of privacy to be applied to the chat message), via configuration of a chat participant profile associated with the chat participant (e.g., for configuring privacy for groups of messages, for chat sessions or groups of chat sessions, or the like), or the like, as well as various combinations thereof.

The chat-based system 100, for a given chat message sent by a chat participant and having a message attribution indicative that the message was sent by the chat participant, may be configured to maintain the message attribution for the message absent an indication that the message attribution for the message is to be modified. For example, when a message attribution setting of INDIVIDUAL is in effect for a chat participant Alice, messages posted by Alice are propagated to other chat participants of the chat session which an indication that the messages are from Alice.

The chat-based system 100, for a given chat message sent by a chat participant and having a message attribution indicative that the message was sent by the chat participant, may be configured to modify the message attribution for the message to form a modified message attribution for the message where the modified message attribution for the message is configured to hide the fact that the message was sent by the chat participant (e.g., do not have any association of the chat message with the chat participant that sent the chat message) or obscure the fact that the message was sent by the chat participant (e.g., associate the chat message with the chat participant and one or more other chat participants so that it is not clear as to which of the chat participants actually sent the chat message).

In at least some embodiments, the message attribution for a message may be changed from identifying the chat participant which sent the message (e.g., an identifier of the chat participant) to a modified message attribution that uses an identifier which hides the fact that the message originated from the chat participant. The identifier which hides the fact that the message originated from the chat participant may be “anonymous” or other similar identifier, an identifier of a virtual chat participant that is generated by the chat-based system 100 for purposes of hiding messages from real chat participants, or the like. For example, when a message attribution setting of ANONYMOUS is in effect for a chat participant Alice, messages posted by Alice are propagated to other chat participants of the chat session which an indication that the messages are anonymous. For example, Alice might want most of her messages to be attributed to her during a chat session, but also may want to vote anonymously at some time during the chat session, in which case Alice could change her message attribution setting from INDIVIDUAL to ANONYMOUS at sometime during the chat session, post her voting-related messages (which would not be attributed to her), and then change her message attribution setting from ANONYMOUS back to INDIVIDUAL such that subsequent posts would be attributed to her.

In at least some embodiments, the message attribution for the message may be changed from identifying the chat participant which sent the message to a modified message attribution that identifies a group (e.g., where messages from chat participants of a group are attributed to a group identifier of the group rather than the identifiers of the individual members of the group).

In at least some embodiments, the group to which messages of a chat participant are attributed may be an existing group. The group to which messages of a chat participant are attributed may be specified by the chat participant, selected automatically on behalf of the chat participant (e.g., by chat-based core 130 or the like), or the like. For example, when a message attribution setting of GROUP is in effect for a chat participant Alice, messages posted by Alice are propagated to other chat participants of the chat session which an indication that the messages are from some unspecified member of a group (e.g., using a group identifier of the group). For example, if Alice is a member of the group “Sales Team” and specifies that her messages should be attributed to that group, then the message attributions of messages originating from Alice are modified from “Alice” to “Sales Team” prior to being delivered to the other chat participants of the chat session. For example, if Alice is a member of multiple groups, Alice may specify a particular group as the source of her message, the source of her message may be selected automatically from among the multiple groups of which Alice is a member (e.g., randomly, based on an ordered or prioritized list specified by Alice, based on content of the message, or the like), or the like, as well as various combinations thereof.

In at least some embodiments, the group to which messages of a chat participant are attributed may be generated on demand. The group may be generated by selecting a subset of the chat participants of the chat session and attributing the message to the selected subset of chat participants of the chat session. The selected subset of chat participants may or may not include the chat participant for which message attribution management is being performed. The attribution of a message to a group formed on demand may be made by attributing the message to the identifiers of the chat participants in the subset of chat participants or attributing the message to a group identifier of a group that is formed to include the chat participants in the subset of chat participants. The selection of the chat participants to include in the group of chat participants may be performed randomly, based on input from the chat participant for which message attribution management is being performed (e.g., the number of chat participants to include in the group of chat participants, identification of one or more chat participants to be included in the group of chat participants, identification of one or more groups from which chat participants to be included in the subset of chat participants are to be selected, or the like), or the like, as well as various combinations thereof). The group may be generated based on an indication that messages of the chat participant are to be attributed with k-participant precision. For example, an indication that messages of the chat participant are to be attributed with 3-participant precision results in modification of the message attribution of the messages from being attributed to the chat participant to being attributed to three chat participants (e.g., either via use of the identifiers of the chat participants in the subset of chat participants or use of a group identifier of a group that is formed and includes the three chat participants). For example, Alice might specify 3-participant precision during a chat session with Bob and Charlie and two people each may then be selected from the chat buddy lists of Bob and Charlie in order to form multiple three-person groups (which may be distinct or overlapping) such that Bob and Charlie would see messages from Alice as being attributed to those groups.

In at least some embodiments, chat-based system 100 may be configured to provide various levels or degrees of privacy to chat participants in a chat session by enabling chat participants to control the level of privacy applied to messages exchanged within the context of chat sessions and, further by ensuring that the privacy applied to message exchanged within the context of chat sessions is maintained outside of the chat sessions as well. For example, when a communication session leads to records of participant contributions, maintenance of the records of participant contributions should be performed such that the attribution specifications in place during the production of those contributions are honored.

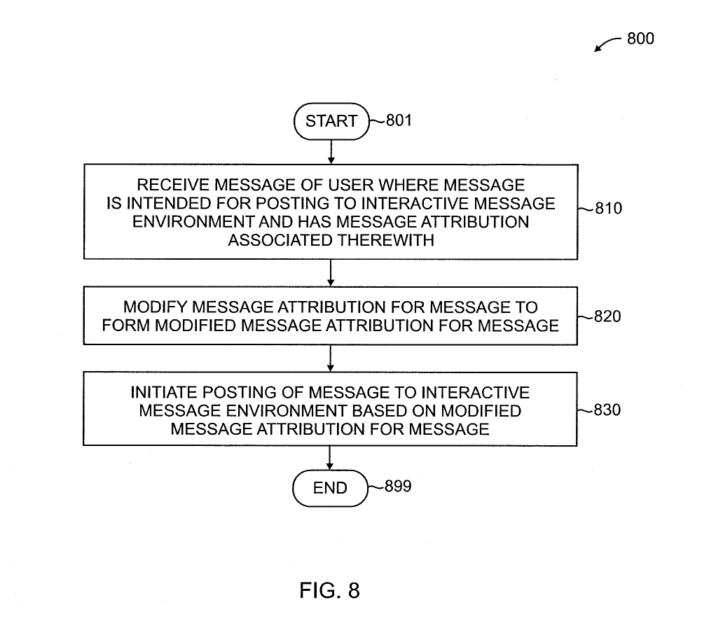

It will be appreciated that, although primarily described with respect to embodiments in which message attribution management is performed within the context of a particular type of interactive message environment (namely, a real-time group chat session of a chat-based system such as chat-based system 100 or any other suitable chat-based system supporting real-time group chat sessions), message attribution management may be performed within various other types of interactive message environments. For example, message attribution management may be performed within the context of other types of interactive message environments supporting real-time group chat sessions (e.g., a group chat or instant messenger capability via a social media site, an application that supports real-time messaging between users of user groups, or the like), within the context of interactive message environments supporting posting of messages by users (e.g., online message boards to which users may post and which other users may access in order to view and, optionally, respond to messages), or the like, as well as various combinations thereof. Accordingly, references herein to “interactive message environment” may be read more generally as being or including any system or platform supporting handling of messages having message attributions therewith, where such messages may be automatically delivered to other users (e.g., via a chat session or other similar session supporting automated delivery of messages to users), posted for availability to other users (e.g., where the other users may or may not be notified regarding the availability of the posted messages), or the like, as well as various combinations thereof. Embodiments related to a more general implementation of message attribution management are depicted and described with respect to FIG. 8.

FIG. 8 depicts an exemplary embodiment of a method for supporting message attribution management functions. It will be appreciated that, although depicted and described as being performed serially, at least a portion of the steps of method 800 may be performed contemporaneously or in a different order than as depicted and described with respect to FIG. 8. At step 801, method 800 begins. At step 810, a message of a user is received. The message is intended for posting to an interactive message environment. The message has associated therewith a message attribution for the message, where the message attribution is indicative that the message is attributed to the user. At step 820, the message attribution for the message is modified to form a modified message attribution for the message. At step 830, posting of the message to the interactive message environment, using the modified message attribution for the message, is initiated. At step 899, method 800 ends.

The use of message attribution management functions, whether used within the context of a chat-based interactive message environment or independent of a chat-based interactive message environment, provides various advantages.

The use of message attribution management functions enables fine-grained control over attribution of content during communication sessions, including providing communication participants fine-grained controls among multiple anonymity settings. The use of message attribution management functions enables communication participants to change settings of attribution quickly and easily during communication sessions. The use of message attribution management functions enables alignment of attribution settings of contribution records with the settings at time of the contribution generation. The use of message attribution management functions may enable a person to quickly and conveniently change between privacy levels (e.g., individual attribution in which the message is attributed to the user, less precise attribution (e.g., group attribution in which the message is attributed to a group of users which may or may identify the user from which the message originated), no attribution (e.g., anonymous attribution for the message), or the like) at various granularities (e.g., per message, for groups of messages, within a thread or across threads of an interactive message environment, or the like, as well as various combinations thereof).

It will be appreciated that, although primarily depicted and described with respect to embodiments for controlling attribution of messages within interactive message environments (e.g., a group chat session of a chat application, a group chat session of a social media site, an online message board, or the like), various embodiments for controlling attribution of messages within interactive message environments may be adapted for use in controlling attribution of information or content provided by entities within other types of multiparty situations. For example, various embodiments for controlling attribution of messages within interactive message environments may be adapted for controlling attribution of voice content within the context of a voice conference (e.g., modifying voices, distorting voices, or the like).

Referring again to FIG. 1 it is noted that, as described hereinabove, in at least some embodiments, chat-based system 100 may be configured to support software developer (SD) functions within the context of chat-based system 100 (e.g., software developer functions 401₈ depicted and described with respect to FIG. 4). The SD functions may be configured to enable SDs to interact with chat-based system 100 (e.g., with one or more of chat-based core 130, entity representatives 120, chat applications 112, or the like, as well as various combinations thereof). The SDs may include outside SDs (which also may be referred to as third-party SDs).

In at least some embodiments, the chat-based core 130 (and/or other elements of chat-based system 100) may be configured to support functions which enable SDs to develop software buddies and to make the developed software buddies available to chat-based core 130 (e.g., as chat applications 112 configured to operate within chat-based system 100, as discussed hereinabove), or any other suitable chat-based system, for integrated, coordinated, or interaction-based execution of the developed software buddies within the chat-based system 100. As previously discussed, software buddies may be software modules configured to operate as participants in chat sessions (e.g., receiving and processing chat messages, generating responses to chat messages, generating chat messages for other chat participants, performing actions beyond reacting to chat messages, or the like, as well as various combinations thereof). For example, a conference manager software buddy may be configured to generate a meeting agenda and make it available for conference participants in a shared file, a concierge software buddy configured to initiate requests for reservations at restaurants responsive to requests from other buddies, or the like.

In at least some embodiments, the chat-based core 130 (and/or other elements of chat-based system 100) may be configured to support functions which enable SDs to make elements of chat-based system 100 (e.g., chat-based core 130, entity representatives 120, chat applications 112, or the like) accessible to computer programs or devices being used by the SDs.

In at least some embodiments, at least some such functions may be supported via one or more software development kits (SDKs), one or more software development environments (SDEs), or the like, as well as various combinations thereof.

In at least some embodiments, an SDK or an SDE may be configured to provide a set of functions that create a framework or platform for providing the various functions discussed above. The set of functions may provide a software framework or a software platform.

In at least some embodiments, an SDK or an SDE may be configured to support a function to enable SDs to develop software buddies and to make the developed software buddies available to chat-based core 130. For example, an SD could use an SDK or an SDE to create a software buddy configured to carry out a well-defined role during chat sessions. For example, an SD could use an SDK or an SDE to create a software buddy including message processing mechanisms configured to handle requests normally associated with the entity that the software buddy is intended to represent (e.g., such as a conference manager buddy configured to handle tasks typically handled by a conference manager, a concierge buddy configured to handle requests typically handled by a concierge, or the like). In at least some embodiments, an SDK or an SDE may be configured to provide an SD with an API. The API may include a set of software functions which may be invoked by software developed by the SD. The invocation of at least a portion of the software functions of the API may make the software developed by the SD available for instantiation as a software buddy. The invocation of at least a portion of the software functions of the API may allow instances of the software developed by the SD to become part of and operate within chat-based system 100 (e.g., receiving and sending chat messages, performing various processing functions, or the like, as well as various combinations thereof).

In at least some embodiments, an SDK or SDE may be configured to support a function to enable SDs to make elements of chat-based system 100 (e.g., chat-based core 130, entity representatives 120, chat applications 112, or the like) accessible to computer programs or devices being used by the SDs. In at least some embodiments, an SDK or SDE may be configured to enable chat-based system 100 to become part of or at least interact with a newly-developed software buddy or even a new software system used by the SD for development of software buddies. In at least some embodiments, an SDK or an SDE may support an API configured to provide the SD with a set of access functions that allow newly-developed software buddies to call upon various functions of the chat-based system 100 (e.g., functions of chat-based core 130, functions of one or more entity representatives 120, functions of chat applications 112, or the like, as well as various combinations thereof).

It will be appreciated that, although primarily described with respect to embodiments in which the tools or functions of an SDK or SDE are presented as an API, in at least some embodiments at least a portion of the tools or functions of an SDK or SDE may be presented in one or more contexts other than as an API.

In at least some embodiments, chat-based system 100 (or a similar chat-based system supporting software buddies) may become integrated with, coordinate with, or interact with a larger environment or ecosystem.

It will be appreciated that, although primarily described with respect to embodiments in which SDs interact with chat-based system 100, various embodiments discussed above may be used or adapted to support interaction between SDs and other types of chat-based systems.

It will be appreciated that various embodiments of SD functions for enabling SDs to interact with chat-based system 100 or other chat-based systems may speed the establishment and growth of a software community or software ecosystem to significantly increase the use and value of the chat-based system 100 or other chat-based systems.

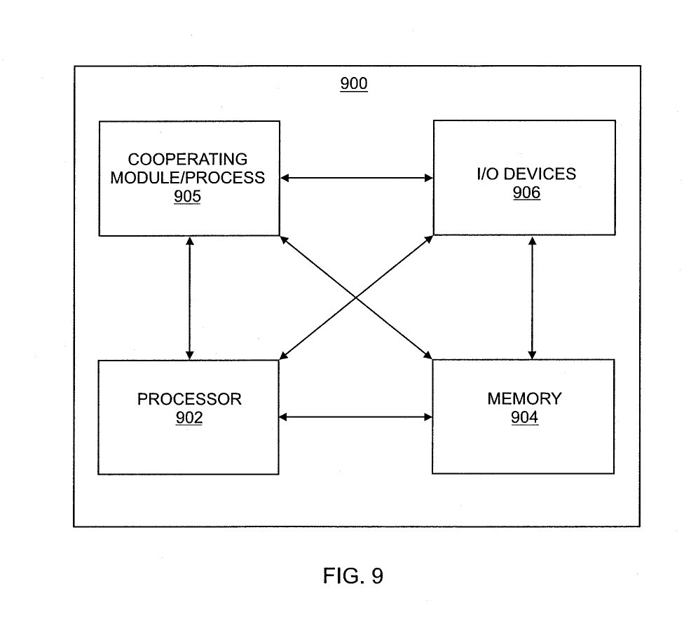

FIG. 9 depicts a high-level block diagram of a computer suitable for use in performing functions described herein.

The computer 900 includes a processor 902 (e.g., a central processing unit (CPU) and/or other suitable processor(s)) and a memory 904 (e.g., random access memory (RAM), read only memory (ROM), and the like). The computer 900 also may include a cooperating module/process 905. The cooperating process 905 can be loaded into memory 904 and executed by the processor 902 to implement functions as discussed herein and, thus, cooperating process 905 (including associated data structures) can be stored on a computer readable storage medium, e.g., RAM memory, magnetic or optical drive or diskette, and the like.

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 900 depicted in FIG. 9 provides a general architecture and functionality suitable for implementing functional elements described herein and/or portions of functional elements described herein. For example, computer 900 provides a general architecture and functionality suitable for implementing one or more of user device 111₁, user device 111₂, one or more entity representatives 120, chat-based core 130, one or more elements of chat-based core 130, one or more functions 401, one or more interfaces 402, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive, via an interactive message environment supporting a user group comprising a set of users, a message from one of the users of the user group; and
perform a control action via the interactive message environment based on a determination that the message includes a question.

2. The apparatus of claim 1, wherein the control action comprises propagating the message toward at least a portion of the users of the user group.

3. The apparatus of claim 1, wherein the control action comprises:
generating a formatted question based on the question included in the message, the formatted question comprising a set of answers available for selection to answer the question; and
propagating the formatted question toward at least a portion of the users of the user group.

4. The apparatus of claim 1, wherein the control action comprises generating a questionnaire based on the question and propagating the questionnaire toward at least a portion of the users of the user group.

5. The apparatus of claim 1, wherein the processor is configured to:
receive, via the interactive message environment, a message including a reference to the question; and
determine a priority of the question based on the message including the reference to the question.

6. The apparatus of claim 1, wherein the processor is configured to:
receive, via the interactive message environment, one or more response messages from one or more of the users of the user group; and
perform a second control action via the interactive messaging system based on the one or more response messages from the one or more other users of the user group.

7. The apparatus of claim 6, wherein the one or more response messages include respective references to the question, wherein the second control action comprises determining a priority of the question relative to at least one other question based on the references to the question.

8. The apparatus of claim 6, wherein the one or more response messages include one or more answers to the question, wherein the second control action comprises propagating the one or more answers toward one or more users of the user group.

9. The apparatus of claim 6, wherein the question has a set of answers association therewith, wherein each of the one or more response messages includes a respective one of the answers of the set of answers, wherein the second control action comprises:
for each of the answers of the set of answers, determining a number of response messages including the answer.

10. A method for controlling interaction between users of a user group, comprising:
using a processor and a memory for:
receiving, via an interactive message environment supporting a user group comprising a set of users, a message from one of the users of the user group; and
performing a control action via the interactive message environment based on a determination that the message includes a question.

11. An apparatus, comprising:
a processor and a memory communicatively connected to the processor, the processor configured to:
receive a message of a user, wherein the message is intended for posting to an interactive message environment, wherein a message attribution for the message is indicative that the message is attributed to the user;
modify the message attribution for the message to form a modified message attribution for the message; and
initiate posting of the message to the interactive message environment using the modified message attribution for the message.

12. The apparatus of claim 11, wherein the interactive message environment comprises a group chat session of a chat application, a group chat session of a social media site, or an online message board.

13. The apparatus of claim 11, wherein the modified message attribution for the message is adapted to prevent attribution of the message to the user.

14. The apparatus of claim 11, wherein the modified message attribution for the message is adapted to prevent attribution of the message solely to the user.

15. The apparatus of claim 11, wherein the message attribution for the message comprises a user identifier of the user for the interactive message environment, wherein the modified message attribution for the message comprises an anonymous indicator.

16. The apparatus of claim 11, wherein the interactive message environment has a group of users associated therewith, wherein the message attribution for the message attributes the message to the user, wherein the modified message attribution for the message attributes to the message to the group of users.

17. The apparatus of claim 11, wherein the message attribution for the message attributes the message to the user, wherein the user is a member of multiple groups of users, wherein the modified message attribution for the message attributes to the message to one of the groups of users.

18. The apparatus of claim 11, wherein the processor is configured to select the one of the groups of users randomly or based on an ordered list of the multiple groups of users.

19. The apparatus of claim 11, wherein the interactive message environment supports a set of registered users, wherein the message attribution for the message attributes the message to the user, wherein the modified message attribution for the message attributes the message to a group of users selected from the set of registered users.

20. The apparatus of claim 19, wherein the processor is configured to generate the group of users based on random selection of at least one registered user from the set of registered users.

21. The apparatus of claim 19, wherein the processor is configured to generate the group of users based on user input of the user.

22. The apparatus of claim 21, wherein the user input of the user comprises at least one of:
a quantity of users to include in the group of users;
an identification of at least one registered user from the set of registered users to include in the group of users; or
an identification of at least one existing user group from which to select at least one user to include in the group of users.

23. A method, comprising:
using a processor and a memory for:
receiving a message of a user, wherein the message is intended for posting to an interactive message environment, wherein a message attribution for the message is indicative that the message is attributed to the user;
modifying the message attribution for the message to form a modified message attribution for the message; and
initiating posting of the message to the interactive message environment using the modified message attribution for the message.
